(19) United States
(12) Patent Application Publication
(10) Pub. No.: US 2011/0297851 A1
(43) Pub. Date: Dec. 8, 2011

(54) LASER PROCESSING WITH ORIENTED SUB-ARRAYS

(75) Inventors: William Lauer, Westford, MA (US); Jonathan S. Ehrmann, Sudbury, MA (US); Joseph J. Griffiths, Winthrop, MA (US)

(73) Assignee: GSI GROUP CORPORATION, Bedford, MA (US)

(21) Appl. No.: 13/153,928

(22) Filed: Jun. 6, 2011

Related U.S. Application Data
(60) Provisional application No. 61/352,316, filed on Jun. 7, 2010.

(51) Int. Cl. G21K 5/00

(52) U.S. Cl. 250/492.1

(57) ABSTRACT

In a system for severing conductive links by laser irradiation to repair electronic devices, multiple laser beams are deflected at high-speed to target selected links for processing by positioning laser spots in a two dimensional pattern during relative motion of a substrate and a beam delivery system. As link targeting flexibility is increased, selection may be required from a large number of addressable link pairs. Various embodiments advantageously use beam deflection and beam splitting to improve memory repair processing rates.

### CROSS-REFERENCE TO RELATED APPLICATIONS

This application claims priority under 35 U.S.C. Section 119(e) to Provisional Application No. 61/352,316, filed on Jun. 7, 2010, which application is incorporated by reference in its entirety.

### BACKGROUND OF THE INVENTION

1. Field of the Invention

The present invention relates to the field of laser processing methods and systems, and specifically, to laser processing methods and systems for laser processing multi-material devices.

2. Description of the Related Art

Lasers can be used in the processing of microstructures in memory and integrated circuit devices. For example, laser pulses can be used to ablate conductive links or link portions in a memory device, such as DRAMs in order to substitute working redundant memory cells for defective memory cells during memory manufacture.

Recently, the use of new materials, such as aluminum, gold, and copper, coupled with the small geometry of these devices, have made the problem of link removal more difficult. Economics and device performance goals have driven the size for the DRAMs and logic devices to very small physical dimensions. Thus, it can be increasingly difficult to irradiate a target structure without damaging surrounding components such as the substrate and adjacent circuitry and links. Furthermore, as more links need to be processed for a given area of semiconductor circuitry, the time required to process a given die increases.

The conventional energy picking process is illustrated in FIGS. 1 and 2. A repeating sequence of laser pulses 1, for example pulses from a q-switched laser, pulses from a sequence of pulse bursts, or a sequence of temporally shaped pulses is generated at a predetermined repetition rate. A group of links 200 having a characteristic spacing d is put in motion relative to a processing head at a predetermined velocity V by moving a stage 100 under control of a control computer or logic 101. As adjacent links move relative to the processing head, there is an associated transit time T1 such that after a period equal to T1, the substrate has moved by an amount equal to the characteristic spacing of the links. Put another way, the link to link period at velocity V relative to the processing head is T1.

In a conventional processing system links and pulses are synchronized. T1 and the period of the laser pulse repetition rate (e.g. the pulse to pulse period of a q-switched laser controlled by trigger signals from the control computer 14) are made equal. With this method, a pulse is available to process every link. Pulses that are synchronized with links to be processed, such as links 200a, 200d, and 200f of FIG. 2, are allowed to reach the targets and process the respective links. Pulses that are synchronized with links that are to remain intact are blocked from reaching the targets by an energy control and energy control pulse selection system 102 of FIG. 1, as indicated by dashed circles in FIG. 2 where the beam would strike if it was not blocked.

It will be appreciated that the time required to process a given set of links within a group of a row or a column of links is approximately the number of link pitches in the group times the time period T1, which in these systems equals the laser pulse repetition rate. If the laser used has a maximum pulse rate of 50 kHz, for example, completing the pass of the beam across the 11 links of FIG. 1 will require at least 200 microseconds.

### SUMMARY OF THE INVENTION

In at least one embodiment, a set of laser spots is generated by splitting an input beam with a multi-beam generator. The set of laser spots is scanned across an array of links in a two dimensional pattern. The pattern scans laterally transverse to a mechanical positioning direction, generally along an array column and across column elements. The pattern also scans in the mechanical positioning direction of links in a column during relative motion of the column and the optical beam delivery system. Multiple column elements pass under the axis of at least one of the split beams for process targeting in an improved processing sequence.

According to one aspect, a single-pass multiple row method of selectively laser processing designated elements in a two dimensional array of elements within the field of view of a laser processing lens is disclosed. The array includes N rows and multiple columns. The method includes generating M simultaneous pulsed laser beams, propagating the beams along M non-collinear beam axes, each non-collinear beam axis passing substantially though the center of the entrance pupil of the laser processing lens, and irradiating L selected array elements in a first column with the beams. M is in a range of 2 to N−1 and L is in the range of 2 to N.

According to another aspect, a single-pass multiple row method of selectively laser processing designated elements in a two dimensional array of elements within the field of view of laser processing lens is disclosed. The array includes N rows and multiple columns. The method includes providing a pulsed laser beam input from a laser source, the pulsed laser beam comprising a sequence of input laser pulses or a sequence of laser pulse groups during multiple corresponding processing periods in a sequence of processing periods, selectively splitting the pulsed laser input during first and second processing periods into a processing output comprising first and second respective pluralities of multiple simultaneous pulsed laser beams, propagating the first and second pluralities along non-collinear beam axes, each non-collinear beam axis passing substantially though the center of the entrance pupil of a laser processing lens, irradiating during the first processing period a first plurality of elements with the first plurality of multiple simultaneous beams, and irradiating during the second processing period a second plurality of elements with the second plurality of multiple simultaneous beams. The first and second plurality of multiple simultaneous beams irradiate different sets of elements at different respective positions in the array relative to the axis of the laser processing lens.

According to another aspect, a laser processing system for single-pass multiple row selective laser processing designated array elements in a two dimensional array of elements is disclosed. The array includes n rows and multiple columns. The system includes a laser source configured to generate a pulsed laser beam input, the pulsed laser beam comprising a sequence of processing periods, each processing period including one or more laser pulses, a processing lens disposed with a focal plane proximate to the array of elements, said lens comprising an optical axis and configured to receive multiple non-collinear simultaneous pulsed laser beams at an entrance pupil and focus each beam to a diffraction limited laser spot within a field of view at the focal plane, at least one laser beam propagation path extending from the laser source to the focal plane of the processing lens, at least one multi-beam generator disposed along a laser propagation path between the laser source and the processing lens configured to receive a pulsed laser beam input and generate multiple non-collinear simultaneous pulsed laser beams from the pulsed laser beam input, said multi-beam generator responsive to beam positioning control signals on a pulse by pulse basis, at least one beam deflector disposed along a laser propagation path between the laser source and the processing lens configured to deflect the multiple non-collinear simultaneous pulsed laser beams within the field of the laser processing lens on a pulse by pulse basis to positions of designated elements during relative motion of the elements and the axis of the laser processing lens axis, and at least one beam adjuster disposed between the at least one multi-beam generator and the processing lens configured to align the multiple non-collinear simultaneous pulsed laser beams with the axis of the laser processing lens at the entrance pupil of the processing lens. The system further includes an array positioning system configured to carry a wafer substrate and provide relative motion between the array and the axis of the laser processing lens, and a system controller configured to receive data corresponding to array elements designated for processing, and provide system control signals including laser timing, multiple beam generation commands, beam deflection commands, beam adjusting signals, lens focusing signals, and relative positioning commands.

According to another aspect, a single-pass multiple row method of selectively laser processing designated elements in a two dimensional array of elements within the field of view of a laser processing lens is disclosed. The method includes determining a plurality of sub-arrays within the two dimensional array of elements, each sub-array including multiple elements designated for processing, selecting one sub-array from the plurality of sub-arrays, the selected sub-array including multiple elements having a predetermined spacing between the elements and a relative orientation within the array of element, and forming laser spots corresponding to locations of the multiple designated elements in the selected sub-array within the field of view of the processing lens with a plurality of simultaneously directed laser beams.

### BRIEF DESCRIPTION OF THE DRAWINGS

FIG. 1 is a block diagram illustrating several conventional components of a laser processing system.

FIG. 2 is a plan view of a row of links illustrating the application of laser pulses to selected links.

FIG. 3A is a block diagram illustrating system elements of a laser processing system according to some implementations.

FIG. 3B illustrates various implementations of a laser pulse.

FIG. 3C illustrates the operation of an acousto optic beam deflector (AOBD) according to some implementations.

FIG. 3D is a block diagram illustrating system elements of a laser processing system according to some implementations.

FIG. 4 illustrates a control architecture according to some implementations.

FIG. 5 illustrates a sequence of laser spots deflected from nominal in-line positions to corresponding elements of an array using column oriented split beam positioning.

FIG. 6 illustrates a sequence of laser spots deflected from nominal in-line positions to corresponding elements of an array using column oriented split beam positioning.

FIG. 7 illustrates a sequence of laser spots deflected from nominal in-line positions to corresponding elements of an array using row oriented split beam positioning.

FIG. 8 illustrates a sequence of laser spots deflected from nominal in-line positions to corresponding elements of an array using row oriented split beam positioning.

FIGS. 9A-9D illustrate various link processing field shapes.

FIG. 9E illustrates an example of laser processing for a staggered row array.

FIG. 10 illustrates a sequence of laser spots deflected from nominal in-line positions to corresponding elements of an array using mixed orientation split beam positioning.

FIG. 11 illustrates a sequence of laser spots deflected from nominal in-line positions to corresponding elements of an array using mixed orientation split beam positioning.

FIG. 12 illustrates a sequence of laser spots deflected from nominal in-line positions to corresponding elements of an array using mixed orientation split beam positioning.

FIG. 13 illustrates a sequence of laser spots deflected from nominal in-line positions to corresponding elements of an array using mixed orientation split beam positioning.

FIG. 14 is a flow chart of column priority processing.

FIG. 15 is a flow chart of row priority processing.

FIG. 16 illustrates beam splitting and subsequent joint beam deflection.

FIG. 17 illustrates split beam axis propagation.

FIG. 18 illustrates compensating for dynamic errors in link position AOBD deflection.

FIG. 19 illustrates correcting for dynamic errors that remain within the AOBD scan field

FIG. 20 illustrates the trade off between dynamic errors and useable offset field size

FIG. 21 illustrates a sequence of laser spots deflected from nominal curvilinear positions to corresponding elements of an array of mixed orientation elements.

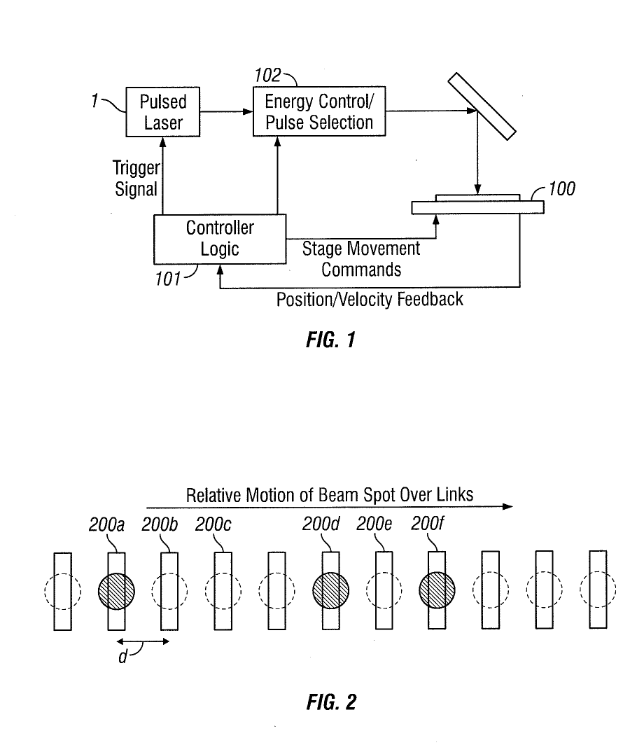

### DETAILED DESCRIPTION OF THE EMBODIMENTS

Many types of scan patterns are well known such as raster scanning, random access scanning, and push broom scans etc. In laser memory repair of electronic devices carried on silicon substrates, path planning is used to scan narrow array areas having few rows and many columns. The scanning pattern trajectory is generally a sequence of line scans where each line includes one or more trajectory segments and one or more groups of links to be processed in an array area that is part of a trajectory segment. Each group of links to be processed has one or more links that are designated for removal by an impinging laser beam such that a conductive element is severed. The scanning pattern is carefully planned in a sequence to traverse all array areas where processing is required in a minimum total process time to process the substrate. In some systems, especially systems with a long travel mechanical positioning stage, scanned lines may traverse a full wafer. In other systems especially systems with a fast short travel mechanical positioning stage, short lines, generally less than the full wafer are scanned to process the wafer region by region.

Laser processing of the areas containing designated links has generally been performed along single rows of array areas with a single laser beam. More recently, attention has been directed to multiple beam systems to target multiple links to increase throughput and minimize the number of processing passes needed to complete processing of a wafer. Multiple processing beams can be applied through a single processing lens with the beams forming spots in different relative orientations relative to the array to process links in a single row or links in different closely spaced rows in a single pass.

In general, patterns used for scanning the array areas for repair by laser irradiation follow the layout of the links in the array areas. Mechanical scanning in one form or another provides relative positioning between the axis of a laser processing lens and designated links. The relative positioning path follows along these link arrays at a positioning velocity to process selected links. Single beam systems delivering a single laser spot are ultimately limited by the minimum processing period of the laser source. Within the limits of maximum mechanical positioning speeds or other system constraints such as pulse selection speed and laser spot positioning accuracy, processing rates may be further limited. Multi-beam systems are intended to improve throughput by allowing multiple laser spots to target links.

While currently available memory repair systems are capable of extremely high throughput, further improvement in processing throughput and positioning accuracy in multi-beam laser processing systems is desirable.

As discussed above, in general, patterns used for single pass scanning multiple rows, like single row processing patterns, follow the layout of the link geometry. However to access multiple rows, in addition to mechanical positioning, multiple row scan patterns of certain embodiments either rapidly position laser spots among the different rows with high-speed deflection or select from a number of multiple beams to deliver laser spots corresponding to each of multiple rows.

As described in U.S. Patent Application Publication No. 2009/0095722, multiple beam systems can scan the link arrays with predetermined patterns based on the layout of links in the array. For example, in one embodiment with laterally disposed beams the number of multiple beams matches the number of rows in the array and spots generated from selected beams result in a so-called push broom scan to process any link in the local array segment when it is traversed. Multiple beams that may be disposed along a single row corresponding to a repeated layout pattern of links, for example to process repeating link groups, spots are moved together from row to row according the repeating pattern of link groups. Multiple-beam processing embodiments, incorporating techniques such as tracking and non-synchronous processing can provide further throughput improvement.

Mechanical positioning strategies for multiple row processing can include determining advantageous optimal relative positioning velocities to improve processing throughput when using pulse by pulse deflection, such as AOBD deflection superimposed with mechanical positioning. Various methods and systems for combining mechanical motion and high-speed deflection are described in U.S. Patent Application Publication No. 2009/0095722, U.S. Provisional Patent Application No. 61/291,282, and U.S. Pat. No. 7,666,759, each of which is incorporated by reference in its entirety herein. With multiple-beam processing, not only can more links be processed with each pulse; mechanical positioning can be maintained at velocities within acceptable limits and pulse utilization can be improved by reducing unused and under-utilized laser pulses.

Memory repair systems of at least one embodiment include a laser source for generating a pulsed processing beam. The processing beam is input to a beam delivery system that includes a multi-beam generator to direct portions of the processing beam to target material at multiple spot locations in a processing output that includes multiple beams capable of processing multiple links simultaneously. The links are carried on a substrate, and the substrate is mechanically positioned along a processing trajectory relative to the beam delivery system. System operation includes using control software, a system controller, firmware, hardware and data storage devices, with interfaces for control signals to various subsystems and components, as well as data input, data processing and data output devices to receive memory repair data, to process the repair data, to generate a processing trajectory and to generate control signals, timing signals and commands for coordinated laser operation, laser beam delivery and mechanical substrate positioning to selectively irradiate designated links along the processing trajectory with multiple laser beams at multiple corresponding laser spot locations.

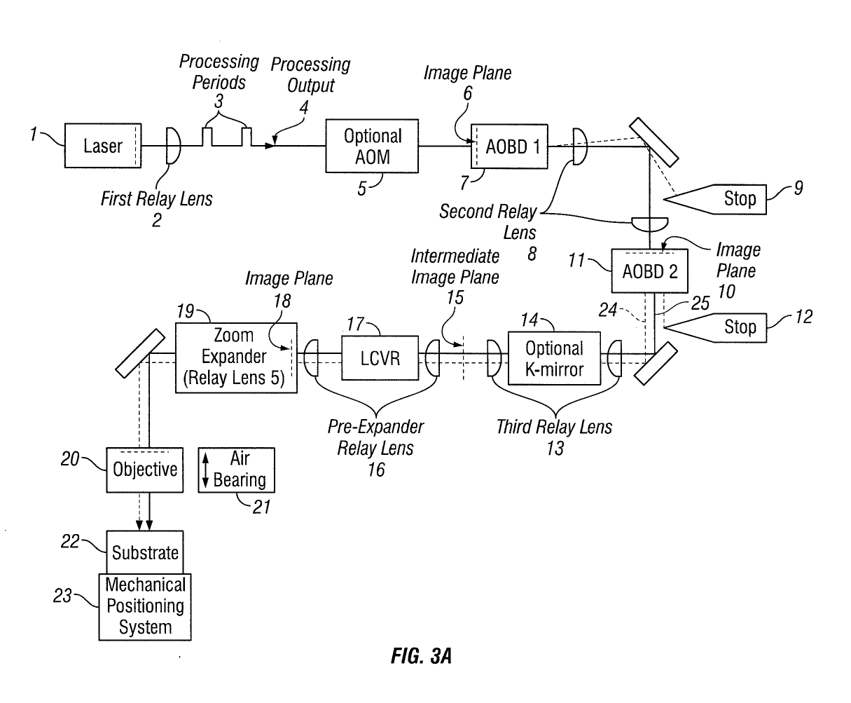

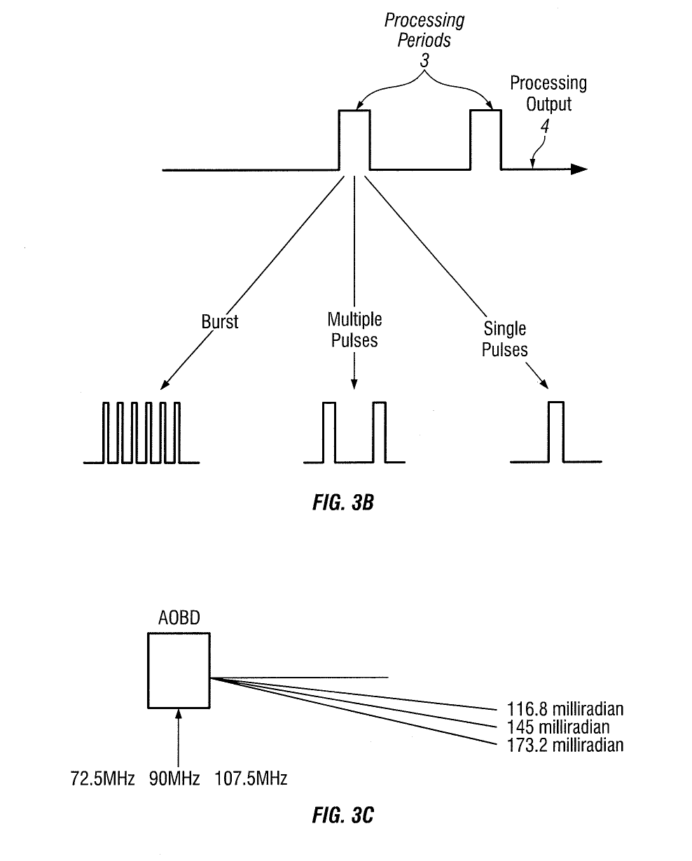

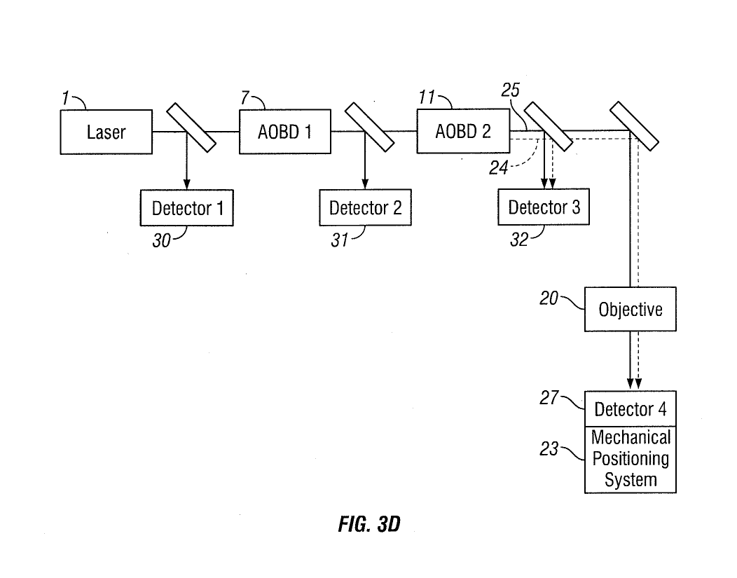

As shown in FIG. 3A, system elements comprising a multi-axis inertialess deflector based laser processing system for link severing include, among other elements, a laser source, multi-axis inertialess deflectors and associated drivers, relay optics, beam expanding optics, spot forming optics, and a mechanical positioning system. As shown in FIG. 3A, a laser 1 outputs a laser pulse through a first relay lens 2. The laser pulses may occur during processing periods 3. An acouto-optic modulator 5 (AOM) may receive the laser pulse at a processing output 4 for selectively blocking some of the output pulses. In at least some embodiments, this AOM 5 is an optional component in the system. A first beam deflector 7 (AOBD 1) may deflect and/or split the received laser pulse along a first axis as described further below. Relay optics may include relay lenses 8 and mirrors for reflecting the laser along the optical path of the system. The system of FIG. 3A includes a first stop 9 which prevents unwanted energy of the first deflector 7 from propagating into the second deflector 11 (AOBD 2).

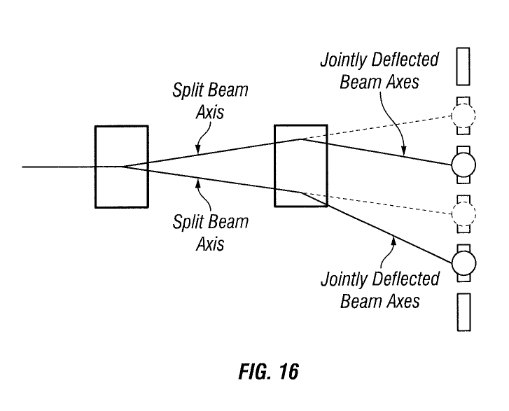

A second deflector 11 may deflect and/or split the laser beam along another axis as will be described further below. The first and/or second deflector 11 may be configured to split the beams into a first beam 24 and a second beam 25 for laser processing. In the specific implementation shown in FIG. 3A, the second deflector 11 splits a deflected beam received from the first deflector 7. Alternatively, the first deflector 7 may be configured to split the beams into the first beam 24 and the second beam 25, and the second deflector 11 may be configured to deflect one or both of the first beam 24 and the second beam 25 (as shown, for example, in FIG. 16). When the deflectors 7, 11, are acousto-optic deflectors, deflecting may be accomplished by applying a single deflection frequency to the crystal, and splitting may be accomplished by simultaneously applying two different deflection frequencies to the crystal. This allows a combination of beam splitting and deflecting that can improve throughput more than heretofore contemplated.

A second stop 12 may prevent unwanted energy from the second deflector 11 from proceeding along the beam path. The beams 24 and 25 may proceed through relay optics as shown in FIG. 3A. The relay optics may include relay lenses 13, optional K-mirror 14, and relay lenses 16. Relay lenses 16 may be formed as pre-expander lenses. A Liquid Crystal Variable Retarder 17 may be used as a polarizing element as will be described below. The beams 24 and 25 may proceed to a zoom expander 19. A mirror may deflect the beam to an objective lens 20. The objective lens 20 may focus the beams on a substrate 22 mounted on a mechanical positioning system 23. One of ordinary skill in the art will recognize that other relay optics and lenses may be employed in order to focus the beams on the substrate 22, reduce aberration or astigmatism, and make the optical system more compact. The operation of the various components will be described in greater detail below.

In at least one embodiment, detectors may be included in the system illustrated in FIG. 3A. FIG. 3D illustrates one configuration of such a system according to some embodiments. A detector 25 may be situated after deflector 7 and before the deflector 11 as shown in FIG. 3D. The system may further include additional detectors 30, 31, and 32 before the deflector 7 and after deflector 11. Each detector detects laser pulse energy and/or average laser power. The detectors may be used to provide feedback to adjust the various components in the system, especially as it relates to maintaining a desired pulse energy on the targets being processed.

Many aspects of this invention are largely independent of laser material interactions and processing energy windows for various regimes of lasers and pulse types. These aspects relate primarily to improved beam positioning and throughput, however to the extent that positioning accuracy is improved or new types of lasers or new modes of operation are used, some aspects may be process related. In general, beam positioning aspects of this invention, using high-speed positioning within in a two dimensional field moving along a trajectory, can apply to many different types of laser processing.

### Laser

The repetition rate of suitable lasers to generate a processing beam of individual pulses, sequential closely spaced pulse groups or sequential rapid bursts of pulses for processing designated links during one or more processing periods may be in the range of 35 kHz to 150 kHz or 100 kHz to 300 kHz. Preferred lasers include fiber lasers with temporal pulse shaping and generation of closely spaced groups of pulses at high processing repetition rates. Laser systems are commercially available with nanosecond pulse shape control and repetition up to 150 kHz and potentially as high as 500 kHz. Other well-known lasers used in the field of micromachining may be used to generate a laser input see for example U.S. Patent Publications 2007/0199927 and 2009/0016388, which are incorporated herein by reference in their entireties.

With returned reference to FIGS. 3A-3B, laser source (1) generates a laser processing output (3). In at least one embodiment, the processing output includes processing periods 3 as shown in FIG. 3B preferably equal to or less than 14 microseconds, during which the laser outputs a single pulse, a shaped pulse, multiple pulses, closely spaced bursts of ultra short pulses or a combination of pulse types. Any type of laser with a pulsed output suitable for severing links may be used, for example q-switched, fiber amplified, and mode-locked lasers. For the purposes of this invention, Processing Repetition Frequency (PRF) will refer to the repetition rate of processing periods. Burst rate will refer the repetition rate of pulses or sub-pulses within a burst. According to some examples, the PRF may be within the range of about 35 kHz to about 135 kHz or from a range of about 100 kHz to about 300 kHz. According to some examples, the PRF meets or exceeds 70 kHz. The PRF may correspond directly to a laser pulse rate or may correspond to a down sampled output rate where a laser source pulses at a rate higher than the PRF. For example, for a 70 kHz q-switched laser the PRF is 70 kHz. For a double pulse laser with 2 pulses falling in the processing period, the PRF would remain 70 kHz. Likewise, for a sequence of bursts the PRF would correspond to the rate of bursts produced for processing regardless of the number of individual pulses in each burst. As described below, the maximum PRF may be limited by the minimum AOBD acoustic pulse width and the pulse stacking capability of the AOBD. Laser wavelength can be any known processing wavelengths, such as UV, visible and Infrared wavelengths and one skilled in the art would select suitable components in the optical path according to wavelength and beam properties. According to some examples, the laser will have a narrow spectral line width of less than 1 nanometer to minimize dispersion effects. Generally the laser beam is a TEM00 Gaussian beam and beam path optics are selected to provide excellent spot uniformity. Various spatial beam modification techniques such as beam shaping and spot shaping can be used.

### AO Devices

### AOBD 1

Output from the laser source is directed along a beam path to the input aperture of a first acousto-optic beam deflector AOBD 1 (beam splitter/deflector 7). As shown in FIG. 3C, AOBD 1 provides controllable beam deflection by Bragg diffraction responsive to a variable frequency RF driver signal and can split the beam when multiple frequencies are applied simultaneously. The deflected beam is generally a first order diffraction beam. The diffraction angle of diffracted beams varies with the RF frequency input, and as a result the diffraction angle is varied and the first order beam is controllably deflected. The beam path to AOBD 1 may include optical elements to modify the beam size and waist position to optimize AOBD 1 performance, for example the path may include a relay lens (2) to image the beam waist onto the AOBD aperture. The beam path to and/or from AOBD 1 or AOBD 2 will generally accommodate the first order center frequency deflection angle; the straight path shown in FIG. 3A is merely a schematic simplification. As is well-known, in some cases anomorphic optics can be employed to image onto an elliptical AOBD window to increase the number of possible imaged spots, and input polarization can be controlled to match AOBD requirements.

Acousto-optic beam deflectors may also be referred to as acousto-optic Bragg deflectors, acousto-optic deflectors (AOD), acousto-optic devices (AOD) or acousto-optic modulators (AOM). Any one of these terms applies to a Bragg regime deflector. AOBD and AOD are considered synonymous and generally refer to devices optimized for variable deflection. AOM usually refers to a Bragg cell that is optimized for high extinction and high efficiency as an amplitude modulator, however over small ranges with varied frequency input an AOM can provide variable beam deflection. The specific construction of the device in various configurations such as, off-axis designs, phased array, alternate materials etc. may be used as beam deflectors in this invention. Other types of acousto optic devices, for example variable filters, may also be considered as deflectors in some cases. It will be understood that any variable deflector operating in the Bragg regime is considered an AOBD for the purposes of this disclosure. Deflectors with similar or superior characteristics may be used in various aspects of this invention, for example deflectors that provide decreased access speed, increased time bandwidth product, improved efficiency, more addressable spots, or reduced beam distortion. Alternate deflectors may be improved AOBDs, electro-optic deflectors or any other type of high speed inertialess deflector.

It will be appreciated that each AOBD is designed for a specific wavelength and that the center frequency will correspond to a different deflection angle for different laser wavelengths. In the case of an optical system designed for different wavelengths, accommodation may be required for differences in deflection angle when the laser source wavelength is changed.

### RF Drivers

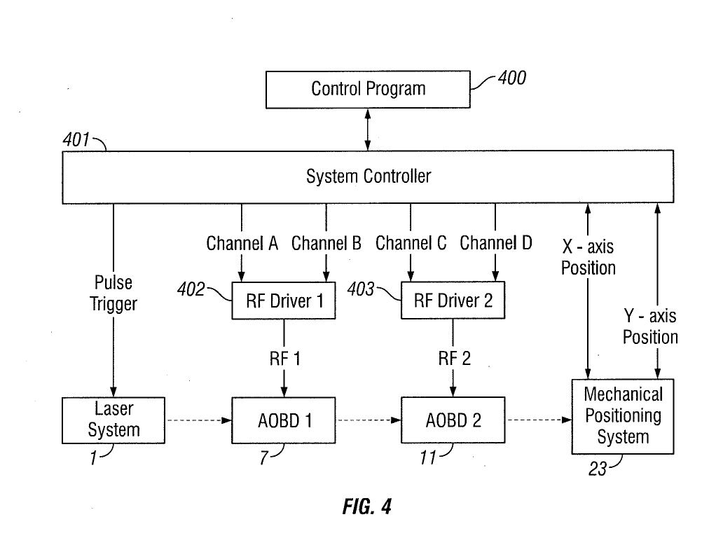

It will be appreciated that AOBDs are driven by specialized RF drives (402, 403 in FIG. 4, for example) that are capable of supplying multiple frequencies to the active deflector cell. Considerations for the RF driver include thermal stability, frequency range, stability and resolution, output power range stability and resolution, number of simultaneous frequencies, frequency switching time, modulation bandwidth, dynamic range, intermodulation, and signal to noise ratio. Drivers may be available as suitable versions from AOBD manufactures or custom as electronic modules.

According to some embodiments, four amplified DDS channels (A, B, C, and D in FIG. 4), 2 per axis are provided to allow a combination of high resolution random access deflection in two dimensions with beam splitting capability in each axis. For beam splitting, 2 frequencies are combined and amplified per axis, each frequency corresponding to a laser spot position in the field. When splitting a beam into more than two beams per axis is desired, additional channels are added for combination and amplification for each axis. A suitable driver multi-channel driver is the 8 channel driver from Crystal Technologies: CTI P/N 97-02861-10, AODR SYNTH DDS 8CH OEM2 STD, CTI P/N 24-00107-01, Driver Amplifier ZHL-2.

### AOBD 2

For two axis deflection, the AOBD 1 (7) may itself be a two axis device with multiple transducers on a single acousto-optic crystal or multiple AOBDs each with its own transducer or transducer array, such as AOBD 1 and AOBD 2 may be used to provide beam deflection in two axes, either in a closely stacked configuration or a spaced-apart configuration. According to some embodiments, AOBD 2 (beam splitter/deflector 11) is spaced apart from AOBD 1 with intervening optics along the beam path to relay the image of the AOBD 1 to AOBD 2. The relay optics 8 may modify the beam diameter as needed to optimize performance of AOBD 2. Anomorphic optics may also be used in this relay stage to impinge AOBD 2 with an elliptical beam. Preferably, the layout provides rotation between first and second deflection axes to allow both deflectors to be mounted in the same preferred orientation. For example, the periscope arrangement of 2 folding mirrors can provide a 90 degree optical path fold and a 90 degree beam rotation. The first mirror folds a horizontal beam to vertical and the second mirror folds the vertical beam back to horizontal with a 90 degree fold with respect to the input horizontal beam. In this example, each AOBD can be mounted to deflect in a vertical plane where the beam rotation between deflectors allows for 2 axis deflection. Folding mirrors may also accommodate, among other things, the first order center frequency input and output angles. Inputs and outputs may deviate from the horizontal plane to match the input Bragg condition and provide an output generally centered with respect to the horizontal plane by adjusting the fold angle to direct the beam along a preferred axis. Other arrangements are possible.

As discussed above, and illustrated in FIG. 3A, AOBD 2 (beam splitter/deflector 11) may be configured to split the laser beam for multiple axis laser processing.

### Knife-Edges

It is to be understood that each AOBD will generate a zero order, non-deflected beam in addition to the desired deflected beam. As a matter of routine design, the zero order beams are fully attenuated for example with a knife edge. The spaced-apart layout provides access for separate knife-edges such as beam stops 9 and 12 or each deflection axis and prevents unwanted energy from the zero order of the first AOBD from propagating into the second AOBD. Other types of beam attenuators are possible, for example in polarization active AOBDs, polarizers maybe used to attenuate zero order energy. In addition to zero order beams, other undesired higher or lower diffraction order beams may be present and may be attenuated in a conventional manner.

### LCVR

Following first and second AOBDs, beam conditioning optics may be employed in the beam path, for example polarization control optics such as a Liquid Crystal Variable Retarder 17 which may be used to adjust polarization according to target type or link orientation as described in U.S. Pat. No. 6,181,728. The beam path may include relay optics 13 to modify the deflected output beam for entrance to the LCVR, for example to fit a well collimated beam into a limited active aperture. These relay optics may further image the pupil of the second AOBD to an intermediate image plane 15 and may provide further anomorphic optics in an anomorphic beam path arrangement.

### Beam Expander

Following the first and second AOBDs and beam conditioning relay optics, the image of the deflector pupil is expanded. A pre-expander relay 16 may reimage the deflector pupil, for example the intermediate image 15 of the deflector pupil described above to the input pupil of the system beam expander 19. As described in U.S. Patent Publication No. 20090095722, a beam expander, preferably a zoom beam expander is used to image the deflector pupil or an image of the deflector pupil to the entrance pupil of the processing objective 20. Position of the zoom beam expander can be used to adjust the deflector pupil image location at the objective pupil to improve telecentricity, and might be adjusted to different axial positions to improve telecentricity of either deflection axis. Beam expander optical groups, for example 3 groups as described in U.S. Patent Publication No. 20090095722, may be driven in linear motion precisely using Nanomotion HR2 piezo drives and MicroE Mercury 2 encoders. As the beam expansion is changed the beam diameter at the objective lens changes, and hence the spot size in the field changes accordingly.

### High Numerical Aperture Objective Lens

The processing lens 20 may be a high numerical aperture objective lens of at least NA 0.7 to provide spots as small as 1.4 microns or 0.7 microns for the processing wavelengths 1064 nm and 532 nm respectively. The objective lens may be mounted on an air bearing, for example air bearing sled 21 as illustrated in FIG. 3A and translated axially according z height positioning commands as described in U.S. Pat. No. 6,483,071. The lens may have a working distance of 6 mm or more to avoid contamination from processing debris and to provide mechanical clearance. The lens may be achromatized to provide spot formation with broadband fiber laser sources or for imaging with auxiliary through the lens viewing equipment. According to some embodiments, the lens may have a field of view of at least +−20 microns with the smallest spot setting and largest input beam. The field of view may be at least +−80 microns for the largest spot setting. According to some embodiments, the field of view will be +−80 for small spots and +−500 micron for large spots. Further, the field may be a flat field with a field curvature less that 10% of the spot depth of focus. Field flatness may be for example 0.1 micron over +−20 microns.

Generally, the field of view of the lens is circular and the deflection field shape is addressed within the lens field of view. The deflection field accessed can be selected as the entire lens field of view, or any portion of the lens field of view. This may be a circular truncation of a superscribed square deflection field, an inscribed shape such as an inscribed square or a partially truncated deflection field. The deflection field when using AOBD positioning is limited by the maximum number of spots available from each deflector. In some cases, for example with small spot sizes, the addressable field may be smaller than the lens field of view.

### Mechanical Positioning System

The wafer substrate 22 with links to be processed is mounted on a wafer chuck for processing. The spot formed by the objective impinges the surface of the wafer. The chuck is carried on a stage or mechanical positioning system 23 according to any of the well-known mechanical positioning configurations. One such configuration is the 2 axis fine stage supported by an air bearing that travels over a 2 dimensional portion of a wafer as found in GSI Group model M550. For this type of system, full wafer coverage is accomplished by stepping a beam delivery system in increments over the wafer and sequentially processing small areas of the wafer with fine stage motion. Alternately, full travel single axis stages in stacked or split arrangements or other configurations and various combinations including galvanometer positioning as know in the art can be used as the mechanical positioning system. Regardless of the particular mechanical positioning configuration, the mechanical positioner moves the substrate relative to a nominal laser beam axis to provide mechanical positioning of targets in a processing trajectory.

Mechanical positioning may also include auxiliary mirror based deflection to provide improved dynamic performance. This has been implemented in the form of galvanometer based field scanning and more recently using a two axis fast scan mirror for stabilization. Yet another approach to improve dynamic performance of mechanical positioning is the use of force cancellation technology, for example as described in U.S. Pat. No. 6,144,118. With force cancellation, mechanical system perturbations and resultant mechanical positioning errors are minimized.

### System Controller

The operation of the laser processing system may be controlled by a system controller. For example, a system control architecture as shown in FIG. 4 may include a system controller 401 and a control program 400 that coordinates mechanical motion, inertialess positioning and laser firing. As shown in FIG. 4, the system controller 401 may communicate with a first RF driver 402 and a second RF driver 403 through communication channels A-D. The RF drivers 402, 403 may drive the AOBD 1 (beam splitter/deflector 7) and the second AOBD 2 (beam splitter/deflector 11) respectively. The system controller 401 may also provide the pulse triggers to the laser system 1, and the X and Y positioning signals to mechanical positioning system 23.

Coordination of laser pulsing, selective pulse picking for blasting selected links, spot displacements to access positions in the deflection field and mechanical stage motion is generally achieved using a system controller 401. The controller is used to generate laser trigger timing signals, pulse picking commands, spot displacement commands and stage positioning commands.

According to some embodiments, the controller generates trigger timing signals that fire laser pulses at a substantially constant repetition rate either continuously or for a minimum interval prior to blasting to provide uniform pulse energy. Conventionally, the trigger timing signals often correspond to link positions on a regular pitch at a particular stage velocity. However, in the present invention, trigger timing signals merely correspond to a position along the mechanical trajectory that will be defined as a virtual link position. The virtual link position represents a position along the trajectory that would be blasted without a commanded displacement. However, with a displacement command, the blast is deflected to the desired blast location at the real link with an offset from the virtual link location. With a constant PRF and a constant velocity along the trajectory, the virtual link locations can generally be regarded as conventional links aligned in along a row on a regular pitch with typical laser timing requirements.

Laser triggering may be initiated by a comparison of the current position of the laser beam axis relative to a target coordinate so that when the position of the laser beam and a virtual link position coincide, accounting for a known lag in the firing sequence, the laser is triggered and the blast is fired to process the target link at the displaced offset position. Alternately, blast times can be scheduled in advance to coincide with virtual link positions according to a planned trajectory and associated blast displacements.

Processing blasts are fired by gating the triggered laser pulses according to pulse picking commands with an optical device (such as AOM 5 of FIG. 3A) to pass working pulses along the optical path to the target and pick-off any unused laser pulses. In some cases the optical device, for example an acousto-optic device, is also used to attenuate pulse energy. Preferably, the optical device is an AOBD that is used for both deflection and attenuation. However, to the extent that pulse equalization methods are employed to provide consistent pulse energy, irregular pulse timing may be possible. It will be appreciated that with certain types of lasers, pulses may be free-running or down sampled and that pulse triggering may correspond to selecting pulses from a sequence of available pulses. A system utilizing this type of laser is further described in U.S. Patent Publication 2008/0029491, the contents of which are incorporated herein by reference in their entirety. In some lasers capable of stable pulse on demand operation, pulse picking may not be required.

The system controller 401 also controls blast displacement relative to the trajectory and provides offset commands and deflection signals to position blasts within the AOBD field. With the use of a deflection field, the controller may generate commands that result from a combination of both time and position processing domains. Displacement can be calculated based on set blast times, blast time can be set based on set displacements, for example if only a limited set of deflections is available, or both blast time and displacement can be set in combination. As a result of the flexibility of this approach, blasts may be fired without either regular target spacing or regular pulse spacing.

Stage positioning commands control the stage motion and position the targets with high precision along the trajectory. Position errors measured or characterized during the trajectory can be accommodated in different ways. For example, errors in either axis can be corrected with corresponding adjustments within the beam deflection field by the AOBDs. When the instant blast position is known to a high accuracy, this method of correction can be used in both constant and non-constant velocity processing. For errors in the direction of mechanical motion, small changes in the timing of scheduled blasts can also be used to correct blast position.

### Stacked Deflector Layout

As discussed, a simple arrangement of stacked AOBDs can be used to provide two axis deflections. This configuration has the advantage of a short optical path length and a limited number of optical components. Disadvantages include beam spreading across the acoustic window of the second device due to the deflection range of the first upstream device. The deflection point is different for each axis which can affect telecentricity at the target surface. Compensation can be provided by adjusting the image location of each deflector with relay optics as described in U.S. Patent Publication No. 20090095722.

### Relay Spaced Deflectors

According to some embodiments, deflectors are spaced apart with relay optics. In this arrangement, the window of the first AOBD is imaged on to the second AOBD. Advantages of this arrangement include the ability to pick-off the zero order beam from the first AOBD before the second AOBD, the elimination of beam spreading across the second deflector window and maintenance of a single deflection origin point and for telecentric spot imaging in the processing field.

### Multiple Relay System

In a preferred embodiment, from the laser output aperture to the processing field, a total of five relays are used. The laser output is imaged to the first AOBD with a first relay lens. Next the first AOBD is imaged to the second AOBD with a second relay which may be for example a pair of lenses spaced according to focal lengths (i.e. a 4 f relay) to achieve a 1× magnification. The second AOBD is imaged with a third relay, which also may be a spaced lens pair, to an intermediate image plane. An optional beam rotor may be located in the optical path of this relay. The intermediate AOBD image is imaged to the input of the zoom telescope relay with a fourth pre-expander relay that may be a spaced lens pair arranged with a magnification to fill the entrance pupil of the zoom beam expander relay. The LCVR aperture may be located in a collimated region of the optical path of the fourth relay. Finally, the zoom telescope relays the input pupil with variable magnification to the objective lens. Thus, the laser beam waist is imaged to AOBD 1, and AOBD 1 is imaged successively to AOBD 2, an intermediate image plane, the entrance pupil of the zoom beam expander and the objective lens in a manner that accommodates an optional beam rotator and a polarization controlling LCVR.

Conveniently, one turning mirror may be located at the intermediate image plane following the second AOBD (not shown) to provide field adjustment without translation. In this case the turning mirror is in the image of each deflector to provide alignment by way of a field angle offset without translating the pupil image.

### Array Dimensions

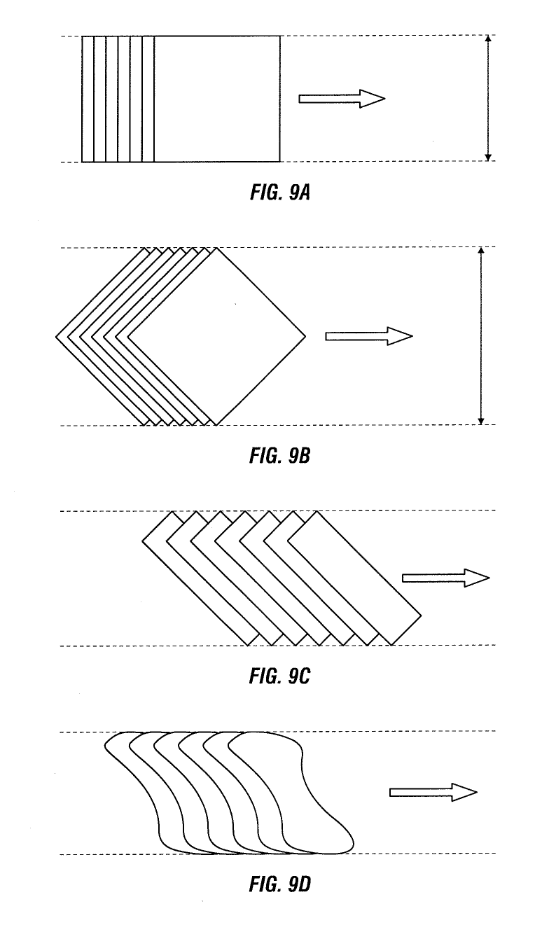

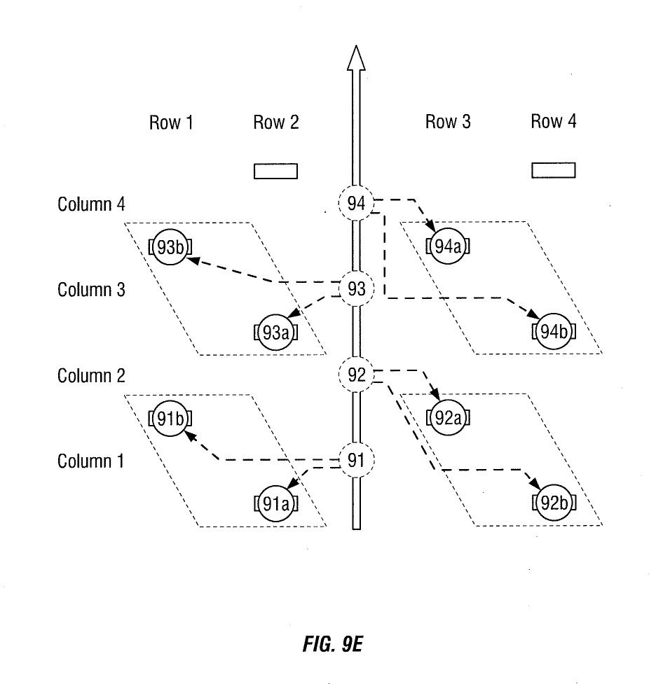

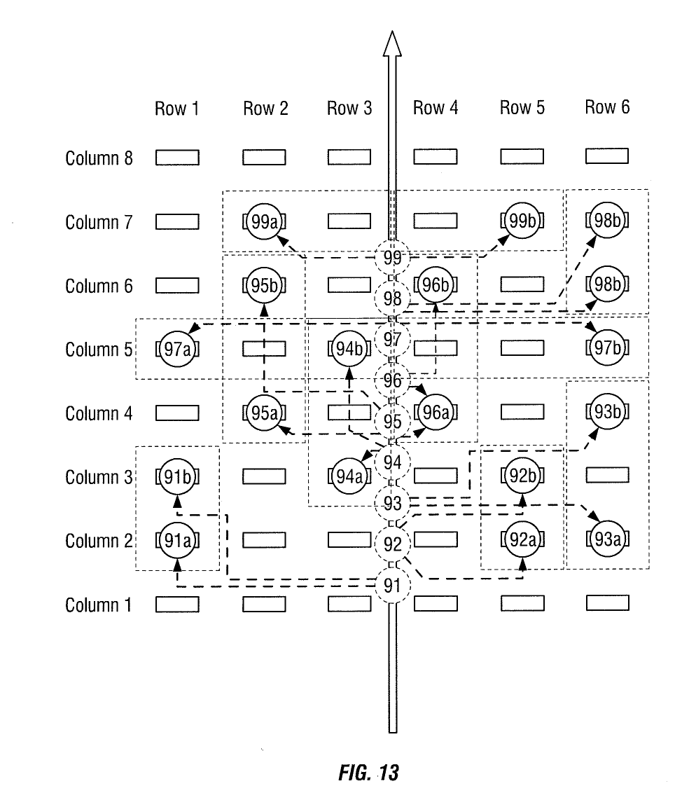

Link arrays will generally have multiple rows in the longest axis, with the long axis corresponding generally to a mechanical scanning axis. Columns are generally orthogonal to rows and transverse to the mechanical scanning axis; however in some cases columns may be diagonally biased. It is to be understood that while an array area may be a full regular grid of elements, other variations, such as link staggering in different rows, a partially filled grid and other layout variations are within the scope of this invention. For example, different local geometries may be used as shown in FIGS. 13-17 of U.S. Patent Publication No. 2009/0095722. Multiple rows and various staggered arrangements of links may be processed. Processing parameters and sequencing algorithms may be predetermined by the general type of layout or may be determined by an initial sequencing of a first device in a group of similar devices for use in subsequent devices or by a first set of link groups within a device for use throughout the device. Processing of a staggered row array will be explained in greater detail with reference to FIG. 9E below.

The closest row and column spacing will typically be limited by array layout and laser material interactions. The furthest row and column spacing will generally be limited by the field of view of the beam delivery system through the processing lens or by the device layout where the array column length is less than the field of view. Row to row spacing will generally be less than 500 microns and may be, by way of example only, in range of about 1 to 40 microns, and in some cases 2.5 to about 10 microns or 2.9 microns to 5.4 microns in some devices. The column to column spacing will be limited by link layout, minimum link pitch and fine-pitch laser processing window considerations. For example, link pitches may be within a range of 0.6 microns up to 6.9 microns. For smaller spot sizes and effectively smaller spot sizes in threshold limited material interactions, even smaller link pitches may be processed. The targets may be so-called island type fuses approximately 0.9 microns wide along the row and approximately 1.5 microns long along the column. Some fuses may be as narrow as 0.3 or even 0.1 microns. The array may be regularly spaced or irregularly spaced with intervening structures or spaces. In at least one embodiment, the target array includes 6 closely spaced rows and extends through a plurality of closely spaced columns. The 6 rows may be in 2 groups of the rows with an intervening structure between the 2 groups.

It will be appreciated that within an addressable field of view, for example a square field of 80 microns or more along each axis positioned to encompass at least a portion of an array, there may be a portion of the array of about 6 rows and 12 to 60 or more columns within the field of view. This portion will include many addressable links, for example 50-300 or more links within the addressable field that can be targeted during any particular laser processing period at any particular blast time. One task to be performed in multiple beam processing is selecting which multiple links are to be simultaneously targeted with which pulses. With a large number of links falling within the field of view, there are many combinations of links that can be addressed simultaneously as described in the following illustrative example.

First, considering only pairs of links in a single column, there are 15 link pair combinations in the column. Now considering these 15 combinations across 12 addressable columns, there would be 180 different link pair combinations. Further, considering link pairs oriented only along rows, there are about 396 different link pairs. If selected orthogonal orientations are allowed for link pair combinations in either rows or columns, then there are about 576 combinations. Lastly, considering any combination of 2 links to form a link pair there would be about 2556 combinations. Therefore, as link targeting flexibility is increased, selection may be required from a large number of addressable link pairs.

### Beam Positioning

When links are spaced on a regular link pitch and each link passes under the axis of a laser beam, the stage velocity can be calculated based on a fixed laser repetition rate. When multiple beams are used to process multiple rows simultaneously, the stage velocity can be reduced inverse to the number of rows being processed. This same speed reduction can be applied even when a single beam is used and scanned along a column of links. For high repetition rate sources, for example, 200 kHz or 300 kHz sources, or multiple combined sources generating a high effective repetition rate, stage velocity may be inadequate for synchronized processing. That is to say that the stage may be unable to provide motion at higher translation speeds with the requisite precision needed for laser spot positioning and successful laser processing. High-speed lateral scanning on a column basis, for example raster scanning with AOBDs or other high-speed scanners, allows lower stage velocities and permits utilization of high repetition rate sources.

Now, when M split beams are used with synchronized pulse triggering to process N multiple rows, the stage velocity relative to conventional (synchronized) single row processing is changed by a factor of approximately M/N. Thus, whenever M<N stage velocity can be reduced while operating the laser at its maximum practical repetition rate or other set repetition rate. Operating a laser at its maximum repetition rate with a maximum number of multiple beams provides a maximum potential link blast rate.

When dynamic beam deflection such as AOBD deflection is used, strict synchronization of mechanical positioning velocity and pulse triggering is not required as the AOBD can be used to track link position during relative motion of the substrate and the beam delivery system. The AOBD further provides the capability to split beams with a controlled divergence angle between beams on a pulse by pulse basis. Various embodiments advantageously combine the link tracking and beam splitting capabilities of AOBD based beam delivery to improve memory repair processing rates.

With split beams used for conductive link processing in multiple row arrays, we have found that improved column scanning strategies can be employed when M<N and especially when M=2. In at least one embodiment, spots are oriented along columns to process links in sequence along the column while tracking the column along the stage positioning axis during mechanical positioning. For even numbers of columns using pairs of split beams, there would be no remainder R at the end of each column. Of course for an odd number of rows, a given row would have a single orphan link remaining when sequential pairs of links are processed.

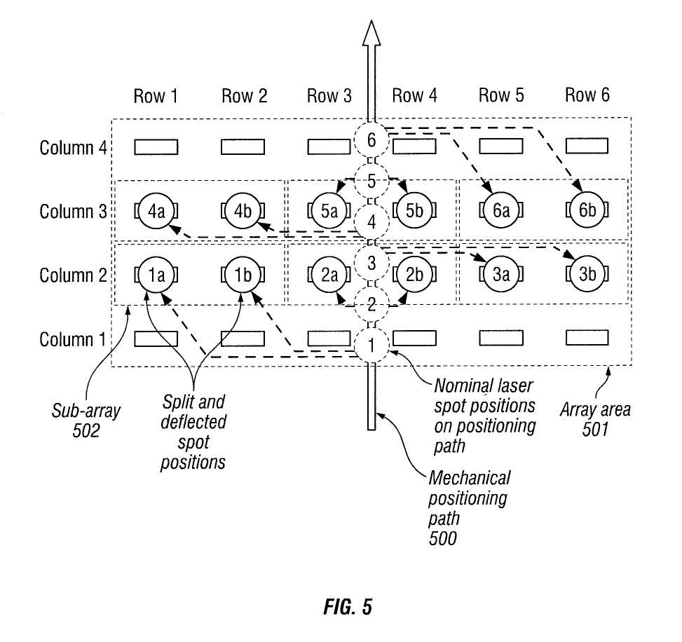

Split beams may be used to process a column in a variety of sequences. As shown in FIG. 5, nominal laser spot positions 1 through 6, occurring at different times in a processing sequence, are incident on mechanical positioning path 500. The links are processed within an array area 501. Spot positions (e.g. 1a, 1b), spacing and number of the laser spots shown in FIG. 5 and shown in similar figures are for the purpose of illustration, and spacing between actual laser spot positions and the number of spots used may be different. For example, in FIG. 5, actual spots may be closely spaced with three spots incident per each column pitch for raster scanning. Links may be processed in adjacent pairs with spots 1a and 1b in rows 1 and 2 followed by spots 2a and 2b in rows 3 and 4, etc. The split and deflected spots may be used to process links in each sub arrays 502 as illustrated in FIG. 5.

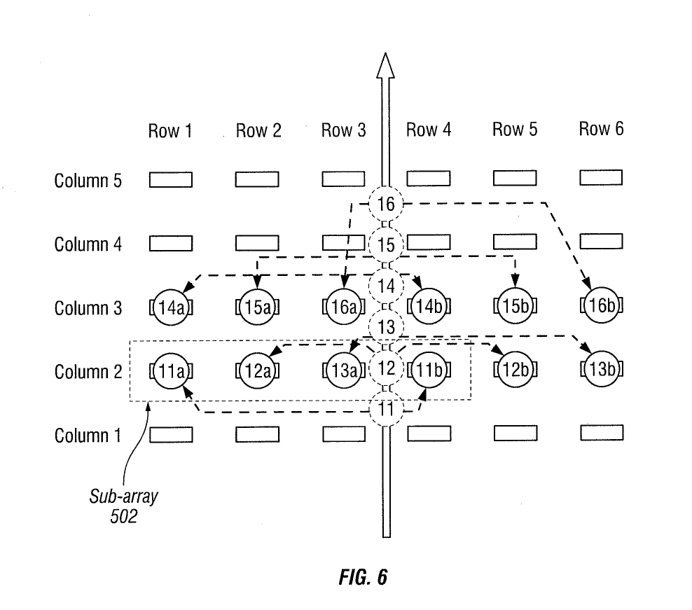

In another example, one spot may start at the end of a column while a second spot starts in the middle of the column and spot separation is maintained while scanning from element to element across the column. For example, as shown in FIG. 6 with a six row array, with spots 11a and 11b in rows 1 and 4 followed by spots 12a and 12b in rows 2 and 5, then spots 13a and 13b in rows 3 and 6. Spots 11a and 11b are used to process two of the links within the subarray 502 as illustrated in FIG. 6. In this example, there may be a link layout stagger accommodated between successive link pairs. Other sequences using different combinations of multiple spots along the column can be used. Processing may proceed generally sequentially or may jump from row to row non-sequentially, e.g. 1 and 4 followed by 3 and 6, then rows 2 and 5. While various examples use only a pair of split beams, it is to be understood that splitting could generate 3 or more beams and further that the number of split beams used may vary within the array or from column to column of the array.

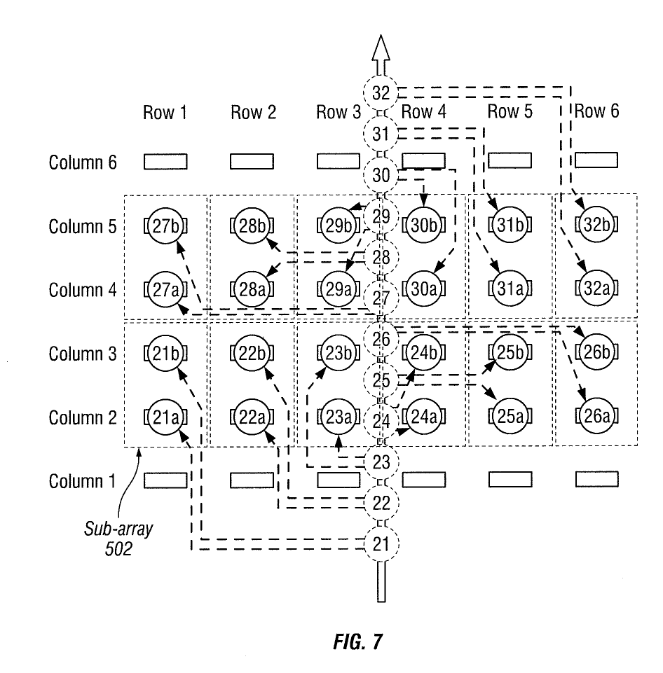

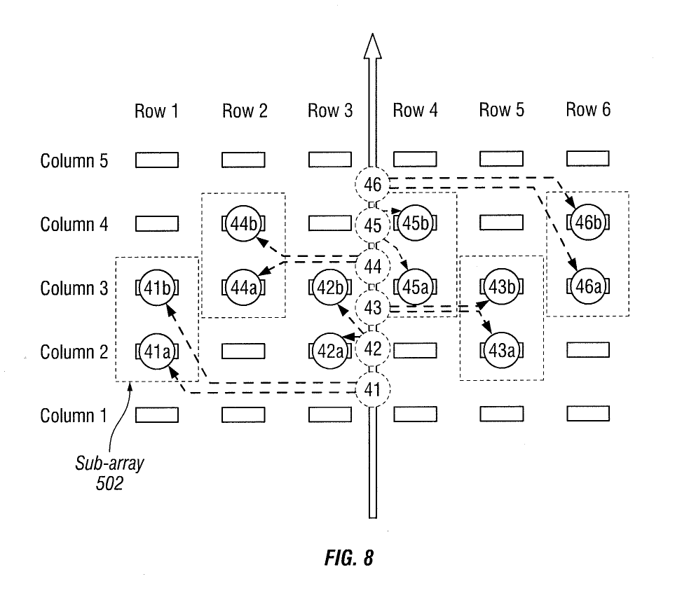

In at least one embodiment, processing occurs with lateral column scanning using spots directed to different columns as shown in FIGS. 7 and 8. Generally, when using AOBDs and propagating the laser generally along a single optical path, spot splitting will be aligned with the AOBD orientation and resulting split beams will be oriented to different columns in the same row. However other techniques such as beam rotation and multiple path deflection can be used to reorient the split beams and direct beams to different rows. With multiple simultaneous column processing, each column can be tracked for stage motion and each split beam can track stage motion. Columns processed can be adjacent or may be spaced apart to the limits of the available beam positioning field of view. In certain cases, beam splitting may occur in multiple orientations to produce a spot array extending along multiple columns, multiple rows, or diagonally along both the column and row directions simultaneously.

For example, as illustrated in FIG. 7, processing may proceed by directing nominal spot locations 21-26 for processing links in row 1 through row 6, and columns 2 and 3. Nominal spot 21 is split to form spots 21a and 21b for processing links in subarray 502 of adjacent columns (columns 2 and 3) of row 1. Each of nominal spot locations 22-26 may be used to sequentially process the remaining links of columns 2 and 3 along rows 1 through 6 as illustrated. Alternatively, as illustrated in FIG. 8, sequential nominal spot locations may be used to process different combinations of columns and rows along the laser processing path. For example, with reference to FIG. 8, nominal spot location 41 may be split to form spots 41a and 41b for processing links in columns 2 and 3 of row 1. Nominal spot location 42 may be used to process links in columns 2 and 3 of row 3. Nominal spot location 43 may be used to process links of columns 2 and 3 of row 5. One of ordinary skill in the art will recognize that other combinations for processing link combinations are possible.

### Sub-Field Selection

Considering the complexity and subtlety of multi-axis AOBD calibration, there may be characteristic deflection field regions that can be more accurately and reliably calibrated and regions that are less accurately and less reliably calibrated. Analysis of field calibration fidelity can be used to identify preferred areas within a calibration domain. A laser processing sequence may be generated to use these preferred areas while avoiding other areas in the calibration domain. In effect, a sweet spot of field calibration is identified and exploited for increased processing performance. For example, characterization of AOBDs may identify angle ranges where efficiency has good linearity especially regarding variable RF power ranges used for attenuation. Even when performance is acceptable across the entire field, a selected portion of the field may be used for the convenience of limiting calibration requirements. A combination of trajectory planning and blast sequencing within the deflection field can be used to effectively avoid areas having lower performance or use only calibrated areas. The field portion or portions used should access all laterally offset blast locations and include sufficient length in the direction of motion to accommodate large scale pulse timing adjustments (e.g. link phase adjustment).

FIGS. 9A-9D show various field orientations and shapes as they progress along a trajectory. FIG. 9A shows the progression of a nominal square field. FIG. 9B shows a tilted field whereby the field diagonal provides for a wide lateral access dimension. A sub-field example shown in FIG. 9C is diagonal strip with a reduced area that maintains access to the full field width and access of at least one link pitch in the direction of travel. An arbitrary sub-field shape is show in FIG. 9D, whereby full lateral access is maintained within a preferred region, such as a stable calibration region. Other desirable field shapes such as round fields may be used.

The different field shapes may be used to process links having different geometric orientations. For example, a tilted scan angle with controlled orientation can be useful for multiple beam processing of adjacent staggered link rows as shown in FIG. 9E. In this case, the scan axis along which a pair of beam paths diverge is neither parallel nor perpendicular to the rows of links. Image rotation in this embodiment can align the scan axis with any variation in link pitch and row separation. As illustrated in FIG. 9E, beams may be split and deflected to process links which are in the adjacent staggered rows. For example, beam 91 may be split to process links using beams 91a and 91b in rows one and two respectively. The resulting tilted field is produced for processing the links, similar to the field illustrated in FIG. 9B above.

### Link Processing Groups

In general, a sub-group of links falling within the addressable field of an AOBD or other high-speed beam positioning device can be considered a sub-array of a local array area, for example links R1C2 . . . R2C2, R1C2 . . . R4C2, and R1C2 . . . R1C3 at laser spots 1a and 1b, 11a and 11b, and 21a and 21b in FIGS. 5, 6, and 7 respectively. These sub-arrays can contain intervening links that are not designated for processing or may contain only adjacent links designated for processing. A sub-array will contain 2 or more links, of which one or more are designated for processing, and for convenience, single links are not considered sub-arrays. Each sub-array can be characterized by the links included, and for single pulse processing, each link designated for processing in a sub-array will be processed either with a portion of a split beam or with a single laser spot. In special cases such as multiple-pulse processing, a link designated for processing may be included in multiple sub-arrays so it is irradiated with multiple laser pulses. Generally, non-designated links are disregarded and a single particular non-designated link may intervene in multiple sub-arrays. However, in some cases, such as considering cumulative damage, non-designated links may receive unique treatment in sub-array selection.

Non-synchronous processing is processing with an optimized positioning velocity that does not correspond precisely to the laser repetition rate and link pitch. Advantages of non-synchronous processing have been previously disclosed in U.S. Patent Publication No. 2009/0095722 and U.S. Provisional Application No. 61/291,282 for processing a sequence of links along a single row or multiple rows. In at least one embodiment, non-synchronous processing is applied to a sequence of links that is scanned on a column by column basis. When different numbers of pulses are used to process different columns, depending on the number of links designated in each column, then the processing dwell time can vary from column to column. This variation can be accommodated with column tracking and a non-synchronous processing sequence. Of course when a column does not include any designated links, the entire column can be skipped over with no expended dwell time. The column by column sequence may progress to the next column with designated links or in some cases may jump forward or backward or jump over columns with designated links such that positioning along the array does not proceed monotonically.

In a simple scheme, with beam splitting oriented along a column, only designated links are processed. When two or more links are processed as a sub-array in a given column, two or more split beams may be used depending on a maximum number of simultaneous split beams. And, when the number of links to be processed in a column is odd and an even number of split beams are used, there will be a single orphan link that requires processing in the column. Thus, when L links are to be processed in a column containing N rows, and when L<N, and especially when L<(N−1), then a non-synchronous approach can be employed to process the column and eliminate at least one pulse to process the column. For example, in a column of an array of six rows N=6 using M=2 spots to process L=4 selected links, the number of processing periods can be reduced from 3 when the entire column is scanned, to 2 pulses where only the selected portion of the column is scanned and processed in 2 sub-arrays.

### Orphan Links

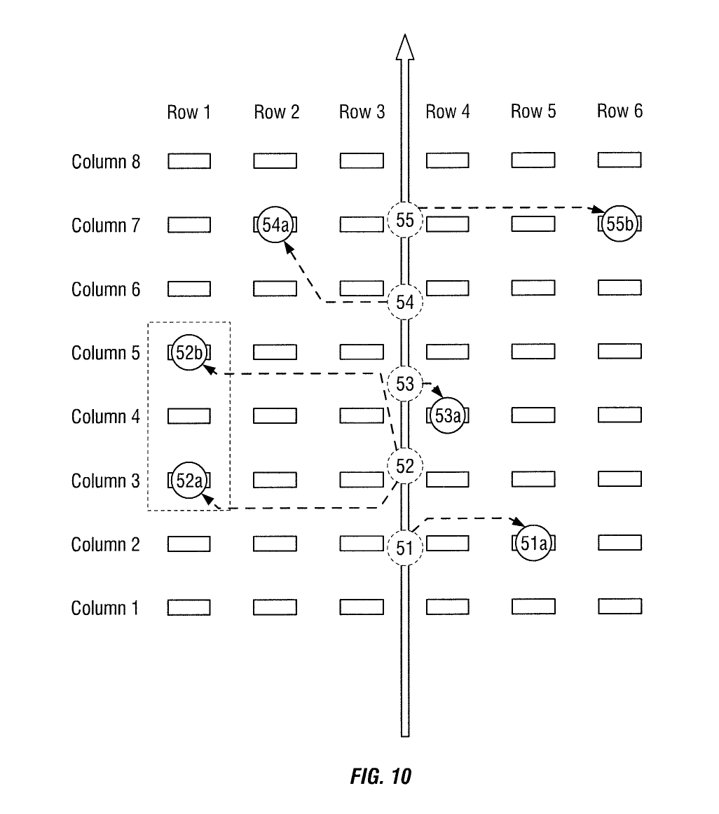

The single remaining orphan link in a column can be processed with a single un-split beam. However, single beams can potentially slow the system down by under utilizing available laser pulse energy. Processing with a minimum number of processing periods can help optimize throughput. Rather than wasting a portion of a processing pulse, preferably the orientation of the beam splitting is set along a row and a second link designated for processing at some other column within the addressable field of view is selected and is processed simultaneously as part of a sub-array with the orphan link in the initial column. This is shown in FIGS. 10, 11, and 12. In this way, single link processing is avoided and pulse energy is better utilized to improve system throughput.

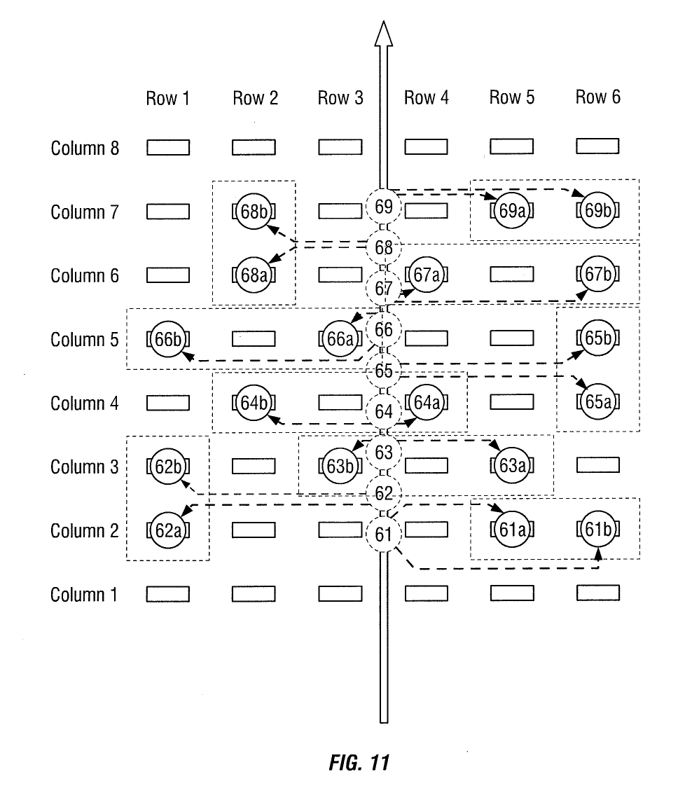

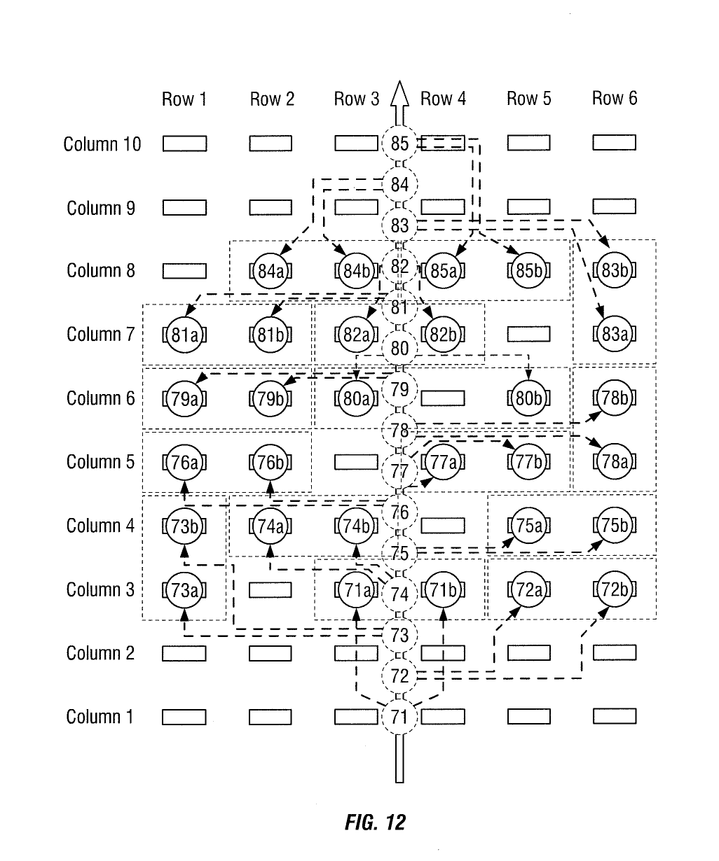

FIG. 10 shows a distribution of one designated link per column and during processing period 52, a split beam is used to simultaneously process at spots 52a and 52b and as a result 5 processing periods process 6 links in 6 columns to save 1 processing period. FIG. 11 shows a distribution of 3 designated links per column using only 9 periods to process 18 links in 6 columns to save 3 periods. FIG. 12 shows a distribution of 5 designated links per column using 15 periods to process 30 links in 6 columns to save 3 processing periods.

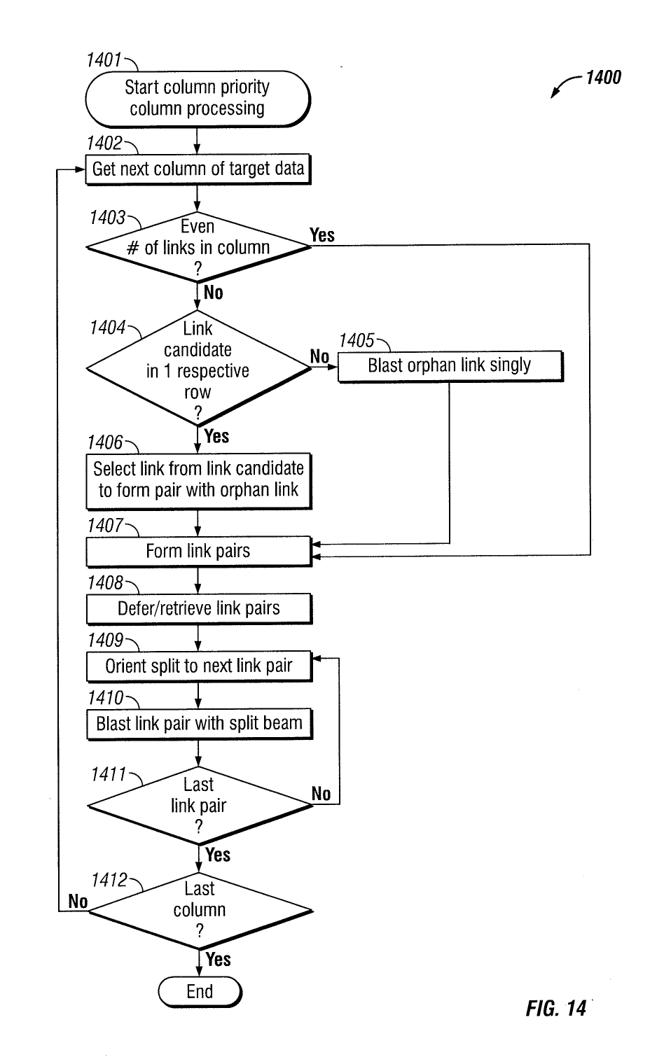

FIG. 11 is an example of a column priority process of processing orphan links which will be explained in greater detail with reference to FIG. 14. In the column priority process of FIG. 11, the default split orientation is along each column of the array. As discussed above, FIG. 11 illustrates a distribution of 3 designated links per column for processing. For example, in column 2, links in rows 1, 5, and 6 are designated for processing, in column 3, links in rows 1, 3, and 5 are designated for processing, etc. The designated links are processed according to a column priority process which will be explained with reference to FIG. 14.

As illustrated in FIG. 14, a method 1400 may begin at begin block 1401 for initiating the column priority processing of links. At block 1402, the next column of target data to be processed is retrieved. At decision block 1403, the method determines if there is an even number of designated links in the column based on the retrieved column data. If it is determined that there exists an even number of designated links for processing within the column, the method proceeds directly to block 1407 for forming link pairs for processing. For example, with reference to FIG. 11, during processing of column 3, nominal spot location 63 is split into first and second spots 63a and 63b for processing the two remaining designated links in column 3. These links are paired with each other for processing as they are the only remaining designated links for processing within column 3.

On the other hand, if it is determined that an odd number of designated links exist in the column, the method proceeds to decision block 1404. At decision block 1404, it is determined whether a link candidate exists in one respective row to pair with one of the links in the same column. That is, with reference to FIG. 11, during processing of column 2, links in rows 1, 5, and 6 are designated for processing. The method determines that a link in one of the respective rows may be paired. For example, in FIG. 11, links in row 1 of columns 2 and 3 are designated for processing and may be paired. Further, the designated link in row 1 of column 2 is paired with the designated link in column 3 as illustrated in FIG. 11 and represented by blocks 1406 and 1407 of FIG. 14. If on the other hand no link candidate exists in one respective row, the orphan link is blasted without splitting the beam as represented by block 1405 of FIG. 14.

Following the pairing of links at block 1407, link pairs may optionally be either deferred for later processing or previously deferred links may be retrieved as the current link pair for processing by the system as illustrated in block 1408. A beam is split and oriented for processing the link pair at block 1409. The link pair is then blasted with the oriented split beam at block 1410. The method proceeds to decision block 1411, for determining if the link pair is the last link pair for processing. If the link pair is not the last link pair within the column, the method returns to block 1409 for orienting the subsequent split beams to the next link pair. On the other hand, if the link pair is the last link pair for processing, the method proceeds to decision block 1412 for determining if the column is the last column for processing. If the column is the last column, the method ends as illustrated in FIG. 14. On the other hand, if the column is not the last column, the method returns to block 1402, where the next column of target data is retrieved.

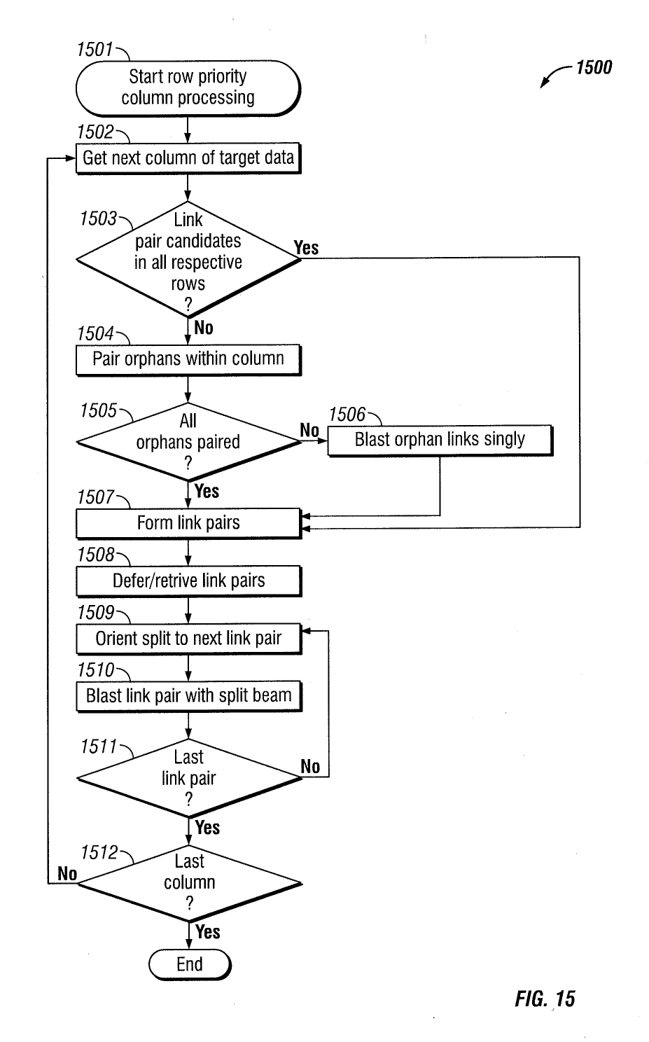

FIG. 13 shows the same designated links as in FIG. 11 with a row priority orientation which will be explained in greater detail with reference to FIG. 15. The method 1500 may begin at begin block 1501 for initiating the row priority column processing of links. The method proceeds to block 1502 for retrieving the next column of target data for processing. At decision block 1503, it is determined whether there exist link pair candidates in all respective rows. If link pair candidates exist, the method proceeds directly to block 1507 and designated links are paired for processing. For example, with reference to FIG. 13, processing of column 2 includes processing of designated links in rows 1, 5, and 6. Designated links in rows 1 and 5 within column 2 have corresponding designated link candidates in column 3. The designated link in row 6 of column 2 also includes a link candidate in column 4 of row 6.

On the other hand, if link pair candidates do not exist in all the respective rows, orphan links are paired within the column at block 1504. For example, with reference to FIG. 13, for processing of links in column 7, links in rows 2 and 5 do not have link pair candidates in the respective rows. As a result, these links are paired within the column.

The method proceeds to decision block 1505 for determining whether all orphan links are paired. If all orphan links have not been paired, the remaining orphan links are blasted with an unsplit beam as represented by block 1506. On the other hand, if all links are paired, the method proceeds to block 1507 for forming the link pairs. At block 1508, link pairs may optionally be either deferred for later processing or previously deferred links may be retrieved as the current link pair for processing. At block 1509, the split beam is oriented to process the next link pair, and the link pair is blasted with the split beam as represented by block 1510. The method proceeds to decision block 1511, for determining if the link pair is the last link pair for processing. If the link pair is not the last link pair, the method returns to block 1509 for orienting the subsequent split beams to the next link pair. On the other hand, if the link pair is the last link pair for processing, the method proceeds to decision block 1512 for determining if the column is the last column for processing. If the column is the last column, the method ends as illustrated in FIG. 15. On the other hand, if the column is not the last column, the method returns to block 1502, where the next column of target data is retrieved.

For processing of an orphan link, there may or may not be a corresponding link to be processed at a different column on a given row containing the orphan link. However, by selecting one or more sub-arrays within the column, any one of the links designated for processing in the column can be selected as the orphan link by exclusion from the selected sub-arrays. Therefore, the row containing the orphan link can be selected based at least in part on the availability of feasible sub-arrays having a link in the row to include in a sub-array with the orphan link. If more than one sub-array is identified on the same or different rows to process the orphan link, then the selection can be optimized. The best sub-array might be, for instance, the sub-array with the shortest distance between links in the sub-array. Alternatively, the best sub-array might contain a link in a second column itself containing an odd number of links so as to leave an even number of links to be processed in the second column. Other optimizations can be made, such as selecting a sub-array with a second link from a second column having the most links to be processed or from a region within the addressable field of field having a high density of links to be processed. Skilled practitioners will recognize other possible optimization parameters.

### Polarization

The array may include elements in different orientations, for example the array may include a portion with links oriented with length along the column as well as a portion with links oriented with length along the row. The portions may be in different areas or may overlap with intermixed link orientations. It is well-know that polarization orientation can affect link processing. Therefore, when links with different orientations are to be processed, polarization orientation can be controlled accordingly with well-known techniques, for example with wave plates, polarization sensitive optical elements, linear variable retarders, high speed electro optic polarization switching devices and other polarization control elements while accommodating polarization sensitivities of certain type of beam deflectors. For example, according to some embodiments, the link processing techniques disclosed my incorporate the polarization techniques described in U.S. Pat. No. 6,987,786, the disclosure of which is incorporated herein by reference in its entirety.

In a simple processing regime, circular or 45 degree polarization may be selected to process mixed link orientations with a split beams an a constant polarization orientation with adequate results. For better optimization, multiple selectable optical paths with a desired polarization orientation imparted along each path may be used to process links based on a selected polarization orientation.

In at least one embodiment, designated link processing may be sequenced, and sub-arrays selected to avoid processing different link orientations with a split beam.

### Intermodulation

Further, beam splitting frequencies especially with an AOBD may be selected using predetermined frequency combinations or may be selected from a set of at least M frequencies that is less than the number of resolvable spots of the deflector and less than the number of N rows or a predetermined number of laterally offset positions required for single-pass processing an array of targets. Such selection may be used for example, to manage intermodulation products. The number of split beams may be limited to two beams or other number less than the number of rows to be processed. As shown in FIG. 16, this type of selection in splitting may require a subsequent deflection that would not have been needed if a larger set of frequencies or an adjustable range of frequencies were used. A secondary deflector can be used to deflect beams that are split with a fixed separation. This allows fixed frequencies for beam splitting and a variable single frequency for deflection.

In some cases, the processing sequence may be based in part by considering undesirable intermodulation effects or other sub-array dependent effects. For example, certain position combinations of multiple beams with respective frequencies may have predetermined undesirable intermodulation effects. Processing of the sub-array may be advanced or delayed in the processing sequence such that different frequencies are used for splitting with more desirable performance. Likewise, lateral positioning of the trajectory may provide a position offset such that frequencies used for processing different rows have reduced intermodulation effects when compare to at least one other lateral position. Some sub-arrays may be processed with single spots to avoid undesirable intermodulation effects. In yet other cases, processing of one or more links may be deferred to subsequent processing passes to eliminate undesirable intermodulation effects for certain predetermined frequencies.

### Process Mode Switching

When processing is limited by maximum stage velocity or the maximum laser processing repetition rate is otherwise limited, the laser repetition rate may be under utilized. The processing mode may be switched accordingly from single to multiple beam processing and visa versa. For example, when processing near mechanical positioning stops, lower positioning speed may be used and a beam splitting mode may be used to increase throughput.

### Double Pass Processing

In at least one embodiment an array is processed in multiple passes with selected designated links deferred for later processing. A first incomplete processing pass is optimized for high efficiency and may use a constant positioning velocity. A second pass preceding or following the first pass performs additional processing and includes at least one processing segment that is shorter than a corresponding segment in the first processing pass. This technique might be used for example to process dense areas of designated links in an array without the need to slow positioning speed of longer processing segments in a single pass processing regime. For example, a processing segment with a generally uniform distribution of designated links may contain a smaller region with double the link density. If there is no feasible way to break-up this segment so as to slow down the positioning velocity to accommodate the higher density area in a single pass, then either the entire segment must be slowed down or the high density area is carved out as a second segment for planning into the positioning trajectory in a different processing pass. However, in this embodiment, half of the links of the high density area would remain in the first segment and half would be carved out for second pass processing. This allows a longer constant velocity segment to be processed in the first segment while reducing the density of links remaining for the second segment. Thus the second segment can be processed at higher efficiency when compared to a second pass where all of the links are carved out. In some cases, the second segment may become a part of a longer but different processing pass, for example including nearby area areas to be processed in a different pass. Deferred processing may also result from other predetermined conditions to avoid undesired effects such as incomplete processing, substrate damages, and neighbor link damage.

### Adjacent and Non-Adjacent Processing

It is to be understood that generally the embodiments herein can include processing of either adjacent links, non-adjacent links or a combination of both adjacent and non-adjacent links. In the case of an array of links, adjacency is to be understood as any two links with no intervening link on any straight line between any point of either link. The array may include structures other than links that may intervene between links, for example structures that intervene between rows and or columns of links in the array. Thus, adjacent links may or may not be adjacent structures depending on the placement of any intervening non-link structure.

For short pulse processing, especially for pulses<10 ns where thermal diffusion length is on the order of the laser spot, any potential damage due to simultaneous processing of adjacent links is reduced compared to longer pulse processing methods. In picosecond processing regimes and shorter, thermal effects on neighboring areas and structure are minimized.

### AO Accessing

When AOBDs are used for beam deflection, the deflection can be either a direct access mode where the acoustic window is filled with a single frequency or in a chirped mode where the acoustic window is filled with a chirp frequency for continuous high speed deflection. In the chirped mode, correction for the well-know cylindrical lensing may be required. Split scanning may include either fixed or variable frequencies.

In at least one embodiment, AOBD scanning is used in a chirped mode for high speed processing. In chirp mode, a variable frequency deflection signal is used so that access time required to fill the acoustic aperture is minimized. Thus, processing repetition periods shorter than the overhead required to fill the acoustic aperture can be accommodated, for example periods shorter than 10 microseconds, for example 3.5 microseconds. Chirped deflection may be used for example for high-speed scanning along columns of the array in combination with mechanical scanning along the row axis of the array. Scanning may be unidirectional or bidirectional, however single direction scanning is preferred to maintain constant lensing effects.

With lateral scanning, focus will be affected by cylindrical lensing in the scan direction along each element in the column. Generally spot size measured in the direction of the narrow link width dimension is critical; however spot size along the length of an element, especially when the element is a conductive link that is longer along the column than across the link in the row direction may not require the same spot size control and may be tolerant of some cylindrical defocusing.

The sign of the chirp rate, indicating a rising or falling signal frequency will determine the direction of defocusing due to cylindrical lensing. To minimize potential substrate damage, it may be beneficial to generate a positive lensing effect, such that the beam waist in the column axis is formed above the element to be processed.

Likewise, chirped scanning can be used to track column position while positioning along the array in the row axis. Generally, the scan rate for column tracking would be lower than the scanning along the column since the column length is generally longer than the column pitch. If chirp rates are matched in a 2-axis deflection system, then the cylindrical focusing effect can be matched to maintain a common offset focus for both axes. For example, a diagonal is scanned by 2 crossed chirped AOBDs. This arrangement could scan the array on a diagonal bias or beam rotation can be used to align the diagonal scan line with the array.

Skilled practitioners will understand that various optical methods can be used to compensate for cylindrical lensing. Compensation may be full compensation such that round focused spots are formed or compensation may be partial compensation. Partial compensation may be used to the control beam shaping artifacts and to generate a prescribed non-round spot shape with a controlled spot shape aspect. Various aspects of non-round spot processing can be found in U.S. Pat. No. 6,639,177.

### Split Path

Aspects of certain embodiments may be practiced in a single path, optical system where all beams are incident on the same set of optical components. In a single path system multiple beams may be offset from an optical path axis propagating with non-collinear beam axes but generally each beam propagates in the same direction in the same sequence near the optical path axis through common optical elements. Alternately, a multiple path system may be implemented using selective beam splitting, beam switching or other means to direct different beams through different sets of optical components or through a single set of components in different sequences. A multiple path system may terminate in multiple focusing lenses, or the paths may be recombined to propagate non-collinear beams axes along a subsequent single path to a single focusing lens.

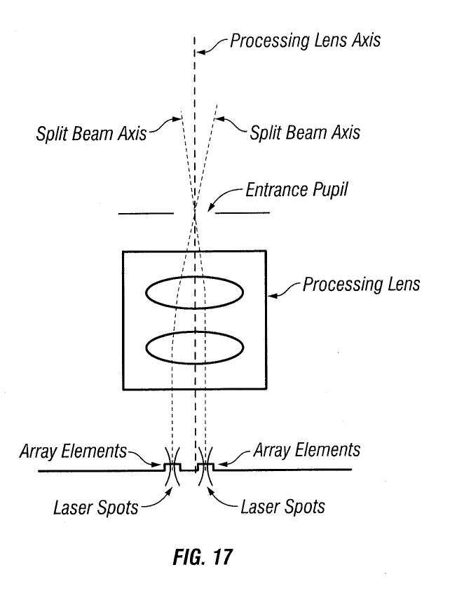

The non-collinear beams are generally centered with respect to the entrance pupil of the laser processing lens so that beam positioning at each target position in the field of view is telecentric. As shown in FIG. 17, at the entrance pupil, each beam will propagate along a vector direction with an azimuth angle and an elevation angle relative to the lens axis. Laser spots, generally diffraction limited laser beam waists, formed at the focal plane of the lens at the array are offset from the lens axis with an orientation corresponding to the azimuth angle and a radial distance corresponding to the lens focal length times the elevation angle. The beam positioning system may include various adjusters for beam alignment, which may among other things, align the multiple beams to the center of the entrance pupil of the processing lens.

Various beam switching techniques can be used such as diffraction based devices and polarization based devices. Although inefficient, fixed power splitting and selective blocking can also be used in multiple path systems.

In particular, high speed scanning, beam splitting and split beam orientation may be accomplished in a multiple path system. For example, one path may be dedicated to deflection and splitting in a first orientation and a second path may be dedicated to deflection and splitting in a second orientation. Alternately, each of multiple paths may independently deflect and or split beams. Preferably, a multi-path system would include independent 2-axis deflection on each path, most preferably high speed deflectors such as AOBDs.

With independent 2 axis deflection in a multi-path system, a greater variety of sub-arrays can be considered for selection. For example, diagonally oriented sub-arrays such as two designated links in different rows and different columns can be simultaneously processed. As such, while there are many more combinations of sub-arrays accessible, considerations for sub-array selections can be simplified. For example, the two paths may simultaneously process sequential designated links in a processing sequence designed for single beam processing.

If beam splitting is used in either or both optical paths of a two path system, 3 and 4 beam dynamic patterns are possible while limiting splitting to 2 frequencies generating two beams with any particular AOBD. Additional paths beyond a two path system and beam splitting beyond 2 beams may be used for more complex dynamic pattern generation.

Split paths could be used to accommodate an AOBD access time that is greater than the laser source repetition period. For example with a 10 microsecond access time, an AOBD can selectively deflect laser pulses up to a 100 kHz rate. With a fast path switch, such as a Pockels cell or other device capable of beam switching at 200 kHz, then a 200 kHz source can be divided between 2 paths, each path deflecting at a 100 kHz rate so that the effective deflection rate of the 2 path system is 200 kHz.

### Correction for Dynamic Errors

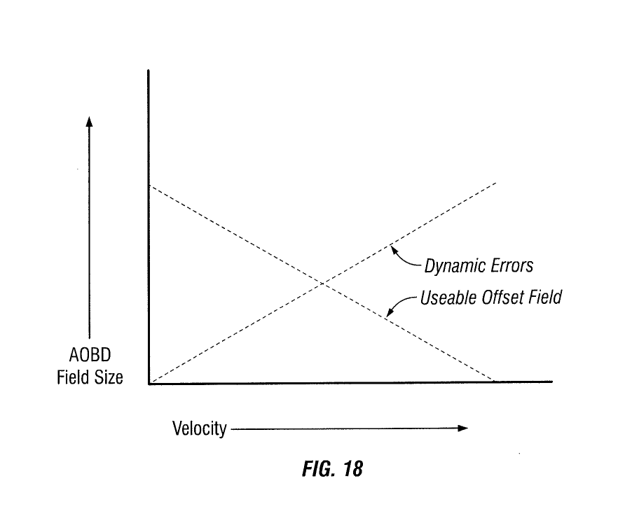

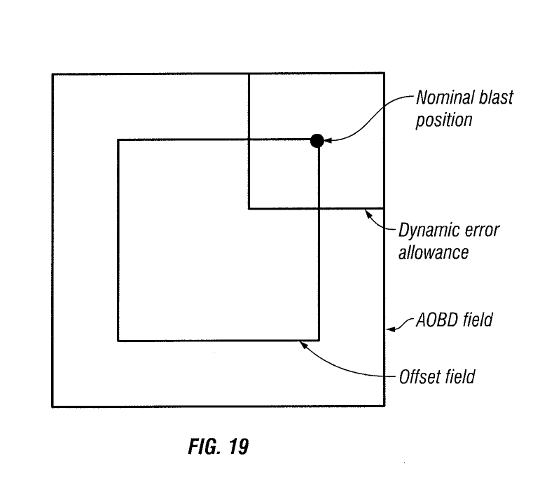

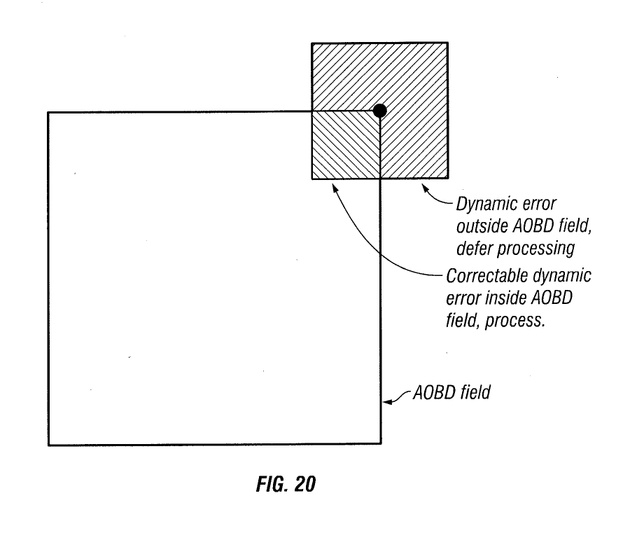

Programmable deflection can be used to correct for dynamic errors in link position that occur as the stage moves. Actual position feedback with the stage can determine the true location of the link as it is about to be processed. FIG. 18 illustrates a graph of velocity vs. AOBD field size according to some implementations. As illustrated, the dynamic errors directly increase as processing velocity and field size increase. Conversely, the useable offset field decreases as velocity and AOBD field size increase. As shown in FIG. 19, the system may use part of the AOBD field as a dynamic error allowance with a smaller offset field within which the nominal positions of the links to be processed appear. As shown in FIG. 20, the full AOBD field can be used as the offset field if link processing is deferred for links that are outside the AOBD field due to dynamic error at the time of processing.

### Multi-Pulse Processing

In certain embodiments, multiple pulse processing can be used to increase repair yields. Some lasers used generate closely spaced pulses such that multiple pulses can be applied to a link during a single processing period. Depending on the interval or intervals between pulses of a multiple pulse processing period, tracking deflection may be used to compensation for tracking errors between subsequent pulses. When pulses are closely spaced, tracking errors are minimized and correction may not be required. When single pulse lasers or their equivalent are used for multiple pulse processing a single link during different processing periods, then positioning of each pulse must be considered as part of the processing trajectory. In this type of trajectory, each designated link may pass under the axis of multiple split beams or under the axis of a single split beam multiple times in a single processing pass over the array area. For random access multi-pulse processing with independently steered beams, the second and subsequent pulses can be delayed a predetermined amount and the sequence of second blasts or other subsequent blast can follow the same sequence as the first blast sequence. This regime may be modified such that the second beam processing second blasts processes with varying delays and using a different processing sequence. In another regime, the first and second beams can alternate between first and second pulse processing. In this case both beams may be processing targets with first blasts at one time and both beams processing with second blasts at a second time. In a combined regime multiple beams can be used to process with first blasts at a first time, with second blasts at a second time, and with first and second blast at a third time. Various aspects of multi-pulse processing such as pulse energy control, variable pulse energies, shapes, durations etc. can be practiced in conjunction with sub-array processing as described, for example in U.S. Pat. No. 7,666,759, U.S. Provisional Application No. 61/291,282, U.S. Pat. No. 7,394,476, and U.S. Patent Publication No. 2009/0095722.

When positioning is limited to split beam processing with a single oriented axis, planning for multi-pulse processing can be significantly more complex. For a predetermined scanning pattern, processing can be planned such that each beam scans with a spatial offset, for example two raster scans column by column and offset along a row by a single column interval. In this case, the entire array would be scanned twice with a delay for the second blast based on the spatial offset of the second beam. It is possible to offset two raster scans by one row interval, with a pair of spots oriented along the column; however there is an inherent inefficiency at the beginning and end of the column where a leading or trailing spot would be unused at either end of the column.

When multiple pulse processing is used with an unsynchronized scan pattern it may not be possible to simply align second blasts with a preset spatial offset. Combined optimization of the first and second blasts can consider available sub-arrays that include two first blast targets, a first and second blast targets or two second blast targets.

### Beam Splitting

Spatial Techniques

Beam splitting is well-known in the field of laser processing. Various beam-splitting arrangements are known and can be categorized by the resulting beam irradiance profiles of the split beams relative to the original input beam. One group of beam splitting uses sub-aperture selection of the input beam. For example a prism may direct one portion of a beam aperture in one direction and a second portion in a different direction. Generally, the irradiance profile of each split beam using the sub-aperture technique will be different and will correspond to the sampled portion of the aperture used to generate a sub-beam. These types of sub-beams may also be called beamlets and might be generated in an array of beams, for example by an array of steerable micro-mirrors or other techniques.

Another approach to beam splitting, and perhaps the most common form of beam splitting is to direct a portion of the entire beam away from the input beam axis. The split beam portion contains a portion of the input beam energy and generally retains the irradiance profile of the input beam. For example, a partially reflective mirror is used to reflect a first portion of a Gaussian beam away from the input beam axis. A second portion is transmitted through the partially reflective mirror. Both the reflected and transmitted portions retain the Gaussian beam spatial profile of the input beam and the normalized profiles of the two beams will substantially match. These and other techniques such as diffraction by gratings and multiple frequency Bragg cells or polarization sensitive selection can be used as a multi-beam generator to split an input beam into multiple beams where each resulting beam maintains the irradiance profile of the input beam and all beams generated by the beam splitting share substantially identically irradiance profiles.

### Temporal Techniques

Another way to divide the energy of an input beam is by temporal energy selection. This includes techniques such as pulse shaping, pulse slicing, pulse picking and the like.

Unless sub-aperture selection, sub-beam generation or a temporal splitting technique is specified, it is to be understood that the terms beam splitting, spatial beam splitting, beam dividing etc. refer to the generation of multiple contemporaneous beams sharing the irradiance profile of the input beam.

### Acceleration Due to a Curvilinear Trajectory

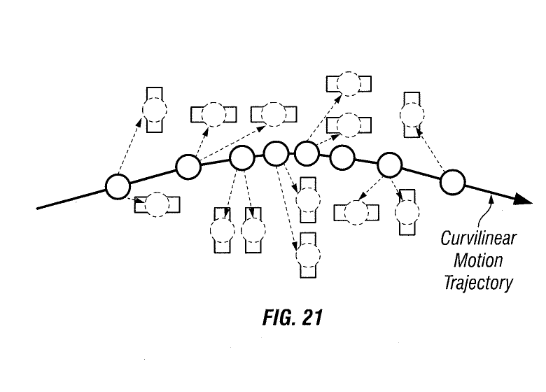

New regimes of trajectory planning can be provided in conjunction with an inertialess deflection field. Since lateral offsets are possible and in general substantial latitude for applying position corrections is available. Curvilinear trajectories or trajectory segments as show in FIG. 21 can be used. As illustrated in FIG. 21, links having different orientations may be simultaneously processed using the split beams. For example, a link having a horizontal orientation may be processed with a first split beam, while a link having a vertical orientation may be processed with the other split beam. Of course, this may be done with straight scan trajectories also. As illustrated, the processing of links having different orientations may be dynamically varied in the processing sequence. Various aspects of link processing with non-constant velocities are also discussed in U.S. Patent Publication No. 2008/0029491, which is incorporated herein by reference in its entirety.

When there are isolated short groups of links, as shown in FIG. 21 these can be processed passing in the sweep of a large radius segment using split beams. Considering potential new layouts of links, curvilinear paths may provide wandering or random access to dense and sparse areas of links that are more efficient than conventional linearly segmented trajectories.

What is claimed is:

1. A single-pass multiple row method of selectively laser processing designated elements in a two dimensional array of elements within the field of view of a laser processing lens, the array having N rows and multiple columns, the method comprising:
generating M simultaneous pulsed laser beams;
propagating the beams along M non-collinear beam axes, each non-collinear beam axis passing substantially though the center of the entrance pupil of the laser processing lens; and
irradiating L selected array elements in a first column with the beams,
wherein M is in a range of 2 to N−1 and L is in the range of 2 to N.

2. The method of claim 1,
wherein generating and propagating occur during a first processing period along a first set of beam axes and occur during other processing periods along different sets of beam axes; and
wherein irradiating comprises irradiating M links in the column during the first processing period with the beams along the first set of beam axes and irradiating a remainder R of L−M links in the first column at one or more different processing periods along at least one different set of beam axes when L>M.

3. The method of claim 2 further comprising simultaneously deflecting the multiple beams to a first group of elements including at least first and second elements in a column during the first processing period and deflecting one of the multiple beams to a third element in the column during the second processing period.

4. The method of claim 2, wherein irradiating comprises generating a first laser pulse during the first processing period and delivering portions of the energy of the first pulse to at least first and second elements of the first column during the first processing period.

5. The method of claim 4 further comprising generating a second laser pulse during the second processing period and delivering a portion of the pulse energy to a third element of the first column during the second processing period.

6. The method of claim 2, wherein the vector direction of each non-collinear beam axis at the center of the entrance pupil of a laser processing lens relative to the axis of the laser processing lens is different.

7. The method of claim 6, wherein the vector directions comprise an azimuth angle and an elevation angle at the entrance pupil of the lens relative to the lens axis and laser spots at the array are offset from the lens axis with an orientation corresponding to the azimuth angle and a radial distance corresponding to the lens focal length times the elevation angle.

8. The method of claim 1, wherein generating comprises:
providing a pulsed laser beam input from a laser source;
splitting the pulsed laser input into a pulsed laser processing output comprising the multiple simultaneously pulsed laser beams; and
wherein the pulsed laser beam input has a characteristic spatial irradiance profile and each of the multiple simultaneously pulsed laser beams have the characteristic spatial irradiance profile after the step of splitting.

9. The method of claim 8, wherein the characteristic spatial profile is one of a Gaussian, a modified Gaussian, a top-hat, and a radially symmetric profile.

10. The method of claim 8, wherein splitting comprises independently controlling pulse energy in each beam.

11. The method of claim 8, wherein splitting comprises generating a predetermined divergence angle between at least 2 non-collinear beam axes and jointly deflecting the at least 2 non-collinear beams to selected elements.

12. The method of claim 8, wherein splitting comprises independently deflecting each beam along non-collinear beam axes.

13. The method of claim 12, wherein splitting comprises controllably deflecting each beam responsive to a positioning command.

14. The method of claim 12, wherein the pulsed laser beams are pulsed at a predetermined process repetition rate and wherein deflecting comprises deflecting on a pulse by pulse basis at the process repetition rate.

15. The method of claim 1, further comprising:
adjusting one or more optical elements along the multiple non-collinear beam axes to align the intersection of the multiple non-collinear beams at the center of the laser processing lens.

16. The method of claim 1, wherein N>2 and at least one column is processed with a plurality of non-simultaneous pulses and wherein at least two elements in the column are processed simultaneously.

17. A single-pass multiple row method of selectively laser processing designated elements in a two dimensional array of elements within the field of view of laser processing lens, the array having N rows and multiple columns, the method comprising:
providing a pulsed laser beam input from a laser source, the pulsed laser beam comprising a sequence of input laser pulses or a sequence of laser pulse groups during multiple corresponding processing periods in a sequence of processing periods;
selectively splitting the pulsed laser input during first and second processing periods into a processing output comprising first and second respective pluralities of multiple simultaneous pulsed laser beams;
propagating the first and second pluralities along non-collinear beam axes, each non-collinear beam axis passing substantially though the center of the entrance pupil of a laser processing lens;
irradiating during the first processing period a first plurality of elements with the first plurality of multiple simultaneous beams; and
irradiating during the second processing period a second plurality of elements with the second plurality of multiple simultaneous beams,
wherein the first and second plurality of multiple simultaneous beams irradiate different sets of elements at different respective positions in the array relative to the axis of the laser processing lens.

18. The method of claim 17 further comprising:
selecting one sub-array from a plurality of feasible sub-arrays for each plurality of multiple beams, each sub-array including multiple elements designated for processing; and
orienting each plurality of multiple beams and forming laser spots corresponding to the designated elements in each sub-array.

19. The method of claim 18, wherein different elements of one column are processed during different processing periods using beams from different orientations of multiple beams.

20. The method of claim 18 further comprising:
moving the array elements along an optimized positioning trajectory relative to the axis of the laser processing lens.

21. The method of claim 20, wherein the trajectory is optimized by the steps of selecting and orienting to improve throughput.

22. The method of claim 21, wherein the optimized trajectory provides processing with a minimum of laser pulses from the laser source.

23. A laser processing system for single-pass multiple row selective laser processing designated array elements in a two dimensional array of elements, the array having n rows and multiple columns, the system comprising:
a laser source configured to generate a pulsed laser beam input, the pulsed laser beam comprising a sequence of processing periods, each processing period including one or more laser pulses;
a processing lens disposed with a focal plane proximate to the array of elements, said lens comprising an optical axis and configured to receive multiple non-collinear simultaneous pulsed laser beams at an entrance pupil and focus each beam to a diffraction limited laser spot within a field of view at the focal plane;
at least one laser beam propagation path extending from the laser source to the focal plane of the processing lens;
at least one multi-beam generator disposed along a laser propagation path between the laser source and the processing lens configured to receive a pulsed laser beam input and generate multiple non-collinear simultaneous pulsed laser beams from the pulsed laser beam input, said multi-beam generator responsive to beam positioning control signals on a pulse by pulse basis;
at least one beam deflector disposed along a laser propagation path between the laser source and the processing lens configured to deflect the multiple non-collinear simultaneous pulsed laser beams within the field of the laser processing lens on a pulse by pulse basis to positions of designated elements during relative motion of the elements and the axis of the laser processing lens axis;
at least one beam adjuster disposed between the at least one multi-beam generator and the processing lens configured to align the multiple non-collinear simultaneous pulsed laser beams with the axis of the laser processing lens at the entrance pupil of the processing lens;
an array positioning system configured to carry a wafer substrate and provide relative motion between the array and the axis of the laser processing lens; and
a system controller configured to receive data corresponding to array elements designated for processing, and provide system control signals including laser timing, multiple beam generation commands, beam deflection commands, beam adjusting signals, lens focusing signals, and relative positioning commands.

24. The system as in claim 23, further comprising at least 2 beam deflectors and at least 2 beam adjusters.

25. A single-pass multiple row method of selectively laser processing designated elements in a two dimensional array of elements within the field of view of a laser processing lens, the method comprising:
determining a plurality of sub-arrays within the two dimensional array of elements, each sub-array including multiple elements designated for processing;
selecting one sub-array from the plurality of sub-arrays, the selected sub-array including multiple elements having a predetermined spacing between the elements and a relative orientation within the array of element; and
forming laser spots corresponding to locations of the multiple designated elements in the selected sub-array within the field of view of the processing lens with a plurality of simultaneously directed laser beams.

26. The method of claim 25, wherein forming laser spots comprises first deflecting a single beam along a first axis, and then splitting the deflected beam along a second orthogonal axis.

27. The method of claim 25, wherein forming laser spots comprises first splitting a single beam along a first axis, and then deflecting the split beams along a second orthogonal axis.

28. The method of claim 25, wherein forming laser spots comprises splitting a first laser beam into N spatially separated laser beams and controlling a set separation angle of at least two of the N spatially separated laser beams, wherein controlling the set separation angle comprises controlling a spacing between respective laser spots at the surface of a substrate including the two-dimensional array of elements.

29. The method of claim 25 comprising processing the array of elements based on a processing repetition frequency (PRF), and wherein the PRF is within the range of about 35 kHz to about 150 kHz.

30. The method of claim 25 comprising processing the array of elements based on a processing repetition frequency (PRF), and wherein the PRF is within the range of about 100 kHz to about 300 kHz.

31. The method of claim 25, wherein a size of the field of view is greater than or equal to about 40 microns.

32. The method of claim 25, wherein a size of the field of view is within the range of about 160 microns to about 1 mm.

33. The method of claim 25, wherein the two-dimensional array of elements is staggered in one dimension of the two-dimensional array.

34. The method of claim 33, wherein the selected sub-array is tilted with respect to a scan direction of the single pass.

35. The method of claim 25, wherein the designated elements of the selected sub-array comprise at least a first designated element and a second designated element, and wherein the first designated element has a different orientation than the second designated element.

36. The method of claim 25, wherein forming laser spots comprises splitting a laser beam into N spatially separated laser beams to process a first sub-array of designated elements, the method further comprising splitting the laser beam into M spatially separated laser beams to process a second sub-array of designated elements, wherein N is not equal to M.

37. The method of claim 25, comprising processing designated elements with sequentially generated laser pulses.

38. The method of claim 37, comprising selecting a first sub-array for laser processing, and a second sub-array for laser processing, the first and second sub-arrays including designated links sequentially arranged along the single path, and wherein selecting one sub-array for processing comprises selecting the second sub-array prior to selecting the first sub-array.

39. The method of claim 25, comprising processing designated elements in at least two rows and at least two columns, and wherein selecting one sub-array comprises selecting one of a maximized number of row oriented sub-arrays for preferentially processing the designated elements with row oriented sub-arrays.

40. The method of claim 25, wherein determining the plurality of sub-arrays further comprises forming link pairs within each row for laser processing, and pairing at least one unpaired designated link with a designated link in a different row and in the same column.

41. The method of claim 25, comprising processing designated elements in at least two rows and at least two columns, and wherein selecting one sub-array comprises selecting one of a maximized number of column oriented sub-arrays for preferentially processing the designated elements with column oriented sub-arrays.

42. The method of claim 25, wherein determining the plurality of sub-arrays further comprises forming link pairs within each column for laser processing, and pairing at least one unpaired designated link with a designated link in a different column and in the same row.

43. The method of claim 25, further comprising sequentially directing laser beams with a first beam having a first polarization and a second beam having a second polarization that is different than the first polarization.

44. The method of claim 43, further comprising selecting at least one of the first and second polarizations based on the designated elements in the selected sub-array.

45. The method of claim 25, wherein forming the laser spots comprises splitting the beam according to a selected low inter-modulation multi-frequency deflector input, and wherein selecting one sub-array from the plurality of sub-arrays comprises selecting the sub-array based at least in part on the low inter-modulation multi-frequency input.
